(19) United States
(12) Patent Application Publication
(10) Pub. No.: US 2012/0302450 A1
(43) Pub. Date: Nov. 29, 2012

(54) Bacterial Metastructure and Methods of Use

(76) Inventors: Bernhard Palsson, San Diego, CA (US); Byung-Kwan Cho, Daejeon (KR)

(21) Appl. No.: 13/504,386

(22) PCT Filed: Oct. 29, 2010
(86) PCT No.: PCT/US10/54857

§ 371 Date: Aug. 14, 2012

Related U.S. Application Data
(60) Provisional application No. 61/256,710, filed on Oct. 30, 2009.

(51) Int. Cl. C40B 20/00; C40B 30/06; C40B 30/00; C40B 40/02

(52) U.S. Cl. 506/2; 506/14; 506/10; 506/7

(57) ABSTRACT

The present invention provides a method of determining bacterial metastructure by integrating multiple genome-scale information yielded by high-throughput technologies. The metastructure constructs a universal metabolic engineering platform enabling a rational design of bacterial strains through optimization of gene and protein expression.

### BACKGROUND OF THE INVENTION

1. Field of the Invention

The invention relates generally to determining the organizational structure of bacterial genomes, and more specifically to methods for iteratively integrating multiple genome-scale measurements on the basis of genetic information flow to identify the organizational elements and mapping them onto the genome sequence.

2. Background Information

Over the last decade, considerable progress has been made in determining whole genome sequences of bacteria and in describing their gene expression states (transcriptomes) and protein content (proteomes). Despite these advances, however, the in-depth organizational structure of bacterial genomes based on such data has not been fully elucidated. Understanding the organizational structure of bacterial genomes is of fundamental importance as it dictates the flow of genetic information at the systems or whole genome level. The organizational structure is understood in terms of the sequence location of all genetic and regulatory elements and how they can be expressed and used. The totality of this information has been termed the ‘metastructure’ of a genome. It is foundational to understanding the makeup, function and engineering of a microorganism.

Contrary to expectations, bacterial genomes are proving to be highly organized into various structural and functional elements. These organizational elements include, but are not limited to, promoters, transcription start sites (TSSs), open reading frames (ORFs), regulatory noncoding regions, untranslated regions (UTRs) and transcription units. A transcription unit (TU) is defined as having one or more ORFs that are transcribed from one promoter into a single mRNA.

With the publication of the first full genome sequence in the mid-1990s, it became possible, in principle, to identify all the gene products involved in complex biological processes in a single organism. In practice, almost 15 years later, such identification has proved to be difficult to accomplish using sequence information alone. Multiple simultaneous genome-scale measurements are therefore needed to identify all gene products and, more generally, to determine their cellular locations and their interactions with the genome (e.g., transcription factor binding to regulatory sequences).

Establishing the organizational structure of a genome is a challenging task. In-depth analyses of the transcriptomes and proteomes of multiple prokaryotic organisms indicate that the information content and structure of a genome is much more complex than previously thought, and that the process of revealing the role of cellular components in transcription and translation on a genome scale has just begun.

### SUMMARY OF THE INVENTION

The present invention is based on the finding that multiple genome-scale measurements may be used to determine the organizational structure of bacterial genomes. As such, the invention provides a method that iteratively integrates multiple genome-scale measurements on the basis of genetic information flow to identify the organizational elements and map them onto the genome sequence. The method includes data generation steps and data integration steps to determine the metastructure of the organism under consideration.

A flowchart of the systematic iterative integration process is given in FIG. 1. Genome-wide data generated by multiple high-throughput (HT) technology platforms, including RNA polymerase binding regions, transcripts, transcription start sites (TSSs) and peptides, re-integrated based on the work flow depicted.

An iterative data integration process using HT data generated from cells grown under different conditions formed the basis for elucidation of the metastructure and lets to the modular genome model. The information generated in this process is: (RBR) RNA polymerase binding region (S, static map; D, dynamic map), (RTS) RNAP-guided transcript segment (RTS), (pORF) potential ORF. All this data is then integrated though defined procedures to generate the metastructure of the genome in the organism under consideration.

In one aspect, the invention provides a method to determine the metastructure of a microbial genome. The method includes (a) the generation of multiple different omics data types (b) systematic integration in a biochemically structured setting and (c) determining the metastructure by finding transcription start sites, translation start sites, binding sites for RNA polymerase and key regulatory protein. The metastructure includes many genetic elements and genomic features elements, including; operons, sub-operons, alternative RNA polymerase binding sites, small RNAs and non-coding regions Importantly, the metastructure leads to important corrections of a sequence based annotation approaches. The metastructure is foundational to understanding the makeup, function and engineering of a microorganism. Engineered bacterial strains can produce chemical entities of commercial value, which are chemicals, antibiotics, therapeutic proteins, nucleotides and peptides. The systematically designed bacterial strains guided by the metastructure can be optimized by the use of adaptive evolution approach and/or computational optimization procedures.

In one embodiment, the method includes the steps of (a) obtaining the full genome sequence a target organism; (b) obtaining the genome-wide binding of RNA polymerase from the organism; (c) obtaining the transcription of RNA from the organism; (d) obtaining the 5′ end sequence of the RNA molecules from the organism; (e) obtaining proteomic data from the total protein isolated from the organism; (f) obtaining the data described in (b) through (e) under a series of culture conditions for the organism; and (g) iteratively mapping the data sets described in (f) onto the DNA sequence in (a) to build the metastructure for the target organism. In another embodiment, the method further includes obtaining transcription boundaries from the genome-wide binding of RNA polymerase and transcription of RNA; assigning the 5′ end sequence of the RNA molecules to each transcription boundary; and assigning the open reading frames to each transcription boundary, thereby identifying modular units on a genome-scale for said target organism. In yet another embodiment, the method further includes determining a change point in the DNA genomic sequence of RNA expression levels; combining the modular units based on the change points into TUs; determining a start of the TU using the TSS data for the lead modular unit in the said combination of modular units; and using the above determinations to define the start and end of the TU under said culture condition, thereby determining TUs on a genome-scale for said target organism under a culture condition.

In certain embodiments, the target organism may be any bacterial or archeal organism. Exemplary methods of obtaining the genome-wide binding of RNA polymerase include, but are not limited to chromatin immunoprecipitation coupled with a microarray, and deep sequencing of immunoprecipitated DNA. Exemplary methods of obtaining the transcription of RNA include, but are not limited to, use of tiled expression arrays and/or use of deep sequencing of the isolated RNA. In certain embodiments, the 5′ end sequence of the RNA molecules is obtained by deep sequencing of RNA. In certain embodiments, the proteomic data from the total protein is obtained by mass spectrometry. In certain embodiments, a list of open reading frames is obtained from said proteomic data. In certain embodiments, the culture conditions are selected from the group consisting of oxygen levels, nutrient levels, temperature, pressure, light, metal, other chemicals, and other environmental stimuli.

In another aspect, the invention provides a method for designing tunable promoters that function in the context of the entire organism to produce a protein in a culture condition specific manner. The method includes identifying a plurality of TUs that contain the same genes but different starting sites; selecting one of said TUs based on start site properties that are used in a culture condition specific manner; choosing said start site properties based on the start site itself and the UTR sequence and its associated regulatory function, thereby expressing the target gene to produce the specified protein under the chosen culture condition. In one embodiment, the protein is a heterologus protein introduced into the modular unit(s) of the TU desired to be produced under the chosen cell culture condition. In another embodiment, the UTR of specified properties is introduced upstream from the gene in a modular unit of interest such that the encoded protein is produced under the chosen cell culture condition.

In another aspect, the invention provides a library of reporter vectors to specify the expression level of a protein in a TU. The library includes a plurality of different plasmids defined by a TSS and 5′UTR derived from the metastructure of said target organism; and a reporter gene that produces a detectable protein product. In one embodiment, a selectable marker gene is introduced to enable the isolating and cloning of a strain that harbors a particular plasmid in the library. In another embodiment, there are different reporter genes in each selected transcription unit represented on a plasmid.

### BRIEF DESCRIPTION OF THE DRAWINGS

FIG. 1 shows a flowchart of the systematic iterative integration process.

FIG. 2 shows an integration of RNAP-binding maps and transcripts results in RNAP-binding regions (RBRs).

FIG. 3 shows that transcriptomic signals were transformed to binary calls and integrated with RBRs resulting in RNAP-guided transcript segments, that is, RTSs (RNAP-guided transcript segments).

FIG. 4 shows determination of TSS by mapping TSS reads to RTS, using a window size of 200 bp and cutoff of 60%.

FIG. 5 shows to address how many ORFs are within one RTS, peptide reads were mapped onto pORFs, which were determined independently of the current genome annotation. RTS can contain multiple pORFs.

FIG. 6 shows the genome-scale regulatory network of sigma factors.

FIG. 7 shows the determination of TUs and use of alternative TSSs. (a) Modular units (MU) are assembled in a condition-dependent manner, resulting in different TUs. Under log phase growth conditions, modular units FWD-1 (containing thrA) and FWD-2 (containing thrBC) are transcribed together forming contiguous TU (TU-1,2,3, based on TSS information). However, stationary phase growth phase triggers transcription of module FWD-1 and FWD-2 separately, defining an additional TU (TU-4). Module FWD-3, resulting in TU-5, is used similarly under log and stationary phase. Dotted lines in the transcription profiles indicate change points of transcription. The change point under stationary phase (star) led to the determination of one additional TU (TU-4). (b) Regulatory elements responsible for differential usage of MUs were measured by the elucidation of σ⁷⁰ and σ^{S} holoenzyme (Eσ⁷⁰ and Eσ^{S}) occupancy within the promoter regions (i, ii) and control region (iii) in log and stationary phase, separately. Significant occupation preferences of σ⁷⁰ and σ^{S} holoenzymes confirmed the convoluted TU architecture.

FIG. 8 shows the stpA gene and the livKHMGF operon have multiple experimentally verified TSSs. The dominant TSS (2,796,558) was detected for the stpA promoter, which is highly activated by the transcription factor Lrp. Therefore, the other two experimentally confirmed TSSs (2,796,578 and 2,796,600) are likely to be used less under this growth condition. The transcription factor Lrp also represses one TSS (3,595,778) of the livK promoter. The other previously confirmed TSS (3,595,753) was observed to be the dominant TSS.

FIG. 9 shows the typical upstream region of a gene, which includes UP element, −35 and −10 region, +1 (TSS), ribosome-binding site (RBS), and translation start site codon (ATG).

FIG. 10 shows the plasmid map for the library.

FIG. 11 shows the overall scheme to construct the engineered strain.

FIG. 12 shows the path for wild-type strain to obtain the optimality.

FIG. 13 shows static and dynamic maps of RNA polymerase binding. Determination of the binding locations of RNA polymerase was nearly condition dependent. Although it was observed that the differential binding levels of RNA polymerase under different conditions, the binding locations (i.e., promoter regions) were nearly identical. (a, b) Examples of RNA polymerase (RNAP) binding under different growth conditions (log phase, red; heat-shocked, grey; stationary phase, orange). Binding of RNAP was determined by the static map although regions of log phase cells or log phase and heat-shocked cells did not show RNAP binding under the dynamic map. Regions of differential binding are highlighted. (c) Static RNAP-binding maps of log phase and leucine condition. It was observed differential RNAP-binding levels, however, the binding locations of RNAP was nearly identical.

FIG. 14 shows a comparison of RNAP-guided transcript segment (RTS) to change point algorithm and running-window approach. Integration of RNA polymerase binding regions (RBRs) with binary transcript calls (BT) lead to RTSs. RTS, based on integration of two experimental derived genome-wide data sets, yielded the best results when compared to change point algorithm (CP) and running window approach (RW). Two examples (a, b), representative for all data, demonstrate that determination of transcription fragments using CP resulted in too many fragments (too sensitive), whereas the RW yielded too few fragments (less sensitive).

FIG. 15 shows an Increase of genomic coverage and accuracy by iterative integration. Iterative integration of transcripts, derived from various growth conditions, with RNA polymerase binding regions (RBRs) resulted in increased genomic coverage and accuracy (a, b, c), genes of interest are highlighted in red. Iteration of data from various growth conditions (log phase; heat-shocked; stationary phase shown) also allowed for determination of condition-specific transcripts, such as yjcC (b) and ybaE (c) from stationary growth phase, and soxR (b) from heat-shocked cells.

FIG. 16 shows the discovery of new transcripts. New transcripts were determined by systematic and iterative integration of RNA polymerase binding regions (RBRs) with binary transcript calls (BT) resulting into RNAP-guided transcript segments (RTSs). New transcripts (highlighted in red) were discovered on opposite strands (a, b), as well as in intergenic regions (c, d).

FIG. 17 shows Flowcharts of the molecular biology tool box for the elucidation of the organizational components. Various genome-scale methods were deployed and developed to determine the meta-structure. Methods are depicted here include (a) transcription profiling, (b) transcription start site (TSS) profiling, (c) chromatin immunoprecipitation coupled to microarrays (ChIP-chip), and (d) proteomics.

FIG. 18 shows Overlapping pORFs. (a) Frequency of peptide detection in the region where overlapped pORFs were found, (b) Examination of translation directionality of the overlapped pORFs based on the mRNA transcript profiles. The arrows indicate false positives that were detected as pORFs.

FIG. 19 shows the number of unique peptides from pORFs with accurate and inaccurate boundaries. Among 803 pORFs mapped to the validated ORFs (from EcoGene), a total of 507 pORFs showed accurate translation start/stop positions (filled circle). pORFs with non-matching translation start positions (296 pORFs) exhibited poor peptide coverage (open circle). Due to this coverage limitation, additional methods (e.g., proteomics with N-terminal modification) have to be applied to obtain a more comprehensive and accurate ORF map at a genome-scale.

FIG. 20 shows use of alternative TSSs. (a) The serA gene, serC-aroA operon, and gltBDF operon have multiple experimentally verified TSSs. The dominant TSS (3,056,478) was detected for the serA promoter, which is highly activated by the transcription factor Lrp. Another experimentally confirmed TSS (3,056,571) is likely to be utilized less under this growth condition. The transcription factor Lrp also activates one experimentally verified TSS (956,818) of the serC promoter, which was detected as a dominant TSS in this study. In addition, another TSS (956,802) was found at the serC promoter. The other previously confirmed TSS (3,352,531) at the gltB promoter was detected as a dominant TSS with Lrp-binding signal. (b) List of TSSs regulated by the transcription factor Lrp. It was observed that the alternative TSSs at the various promoter regions regulated by Lrp.

FIG. 21 shows 5′UTR length of various functional categories. (a) distribution of 5′UTR shows a median length maximum of ˜36 bp, (b) comparison of 5′UTR length (in base pairs) showed no difference between different functional categories.

### DETAILED DESCRIPTION OF THE INVENTION

The present invention provides the novel metastructure of bacterial genomes by integrating multiple genome-scale information yielded by high-throughput technologies. The metastructure of a bacterial genome is comprised of promoters, transcription start (TSSs) and termination sites, open reading frames (ORFs), regulatory noncoding regions (RNRs), untranslated regions (UTRs) and transcription units (TUs). All these elements measured at the genome scale and properly integrated comprise the metastructure of a genome.

Before the present methods are described, it is to be understood that this invention is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Thus, for example, references to “the method” includes one or more methods, and/or steps of the type described herein which will become apparent to those persons skilled in the art upon reading this disclosure and so forth.

Unless defined otherwise, all technical and scientific terms used herein have the same meaning as commonly understood by one of ordinary skill in the art to which this invention belongs. Although any methods and materials similar or equivalent to those described herein can be used in the practice or testing of the invention, the preferred methods and materials are now described.

As used herein, the term “genome” refers to the entirety of an organism's hereditary information. It is encoded either in DNA or, for many types of virus, in RNA. The genome includes both the genes and the non-coding sequences of the DNA. Thus, a “gene” refers to a stretch of DNA that encodes for a functional polypeptide chain or RNA molecule. A gene is limited by a start codon and a stop codon. A codon is a sequence of three adjacent nucleotides in a nucleic acid that code for a specific amino acid. As used herein, the term “genetic” refers to the heritable information encoded in the sequence of DNA nucleotides. As such, the term “genetic characterization” is intended to mean the sequencing, genotyping, comparison, mapping or other assay of the information encoded in DNA. The scope (e.g., extent, scale, etc.) of the genetic characterization is substantially genomic in scale so that a comprehensive assessment of all the genetic elements (known or unknown) can be simultaneously assessed. Substantially comprehensive evaluation ideally includes a full genome-scale re-sequencing of the organism's genome. In cases where full genomic sequencing is not possible, such as due to extensive sequence repeat regions, a comprehensive draft of the genome sequence can be used in the method described.

As used herein, the term “genetic basis” refers to the underlying genetic or genomic cause of a particular observation. Also included in the term is the most important reason for the occurrence of the observation.

A “discrete genomic region” as used herein, is intended to mean a contiguous region or portion of a genome. A genome, or portion thereof, may be fractionated into any number of different discrete genomic regions to be analyzed. In one aspect, a discrete genomic region may be defined as a region of the genome including one or more probe sequences. In another aspect, a discrete genomic region may be defined as a region of the genome that includes two or more probe sequences separated by less than about 10,000, 5,000, 4,000, 3,000, 2,000 or 1,000 base pairs. “Tiling” refers to a process involving analyzing a particular discrete genomic region by moving along the genomic sequence in a frame-wise fashion to determine appropriate probe sequences used to generate probes that are used to manufacture the array. In various aspects, a genomic region may be tiled with different sizes of oligonucleotide sequences. For example, oligonucleotide sequences may be about 15-20, 20-25, 25-30, 30-35, 35-40, 40-45, 45-50, 50-55, 55-60, 60-65, 65-70, 70-75, 75-80, 80-85, 85-90, 90-95 or 95-100 base pairs in length. Additionally, the size of each frame may be determined by the length of the oligonucleotide used to tile the region and the frame of the frame-wise shift may overlap or skip regions of the genomic region by a specific number of base pairs. As such, in various aspects, about 1-25, 25-50, 50-75, 75-100 or more than 100 base pairs may be skipped in the tiling process to determine probe sequences within a region. In an exemplary aspect, tiling of the genomic region is performed using oligonucleotide sequences of about 50 base pairs and about 35 base pairs apart.

As used herein, the term “DNA” or “deoxyribonucleic acid” refers to a nucleic acid that contains the genetic instructions used in the development and functioning of all known living organisms. The main role of DNA molecules is the long-term storage of information.

As used here, the term “RNA” or “ribonucleic acid” refers to a molecule that consists of a long chain of nucleotide units. RNA is very similar to DNA, but differs in a few important structural details: in the cell, RNA is usually single-stranded, while DNA is usually double-stranded; RNA nucleotides contain ribose while DNA contains deoxyribose (a type of ribose that lacks one oxygen atom); and RNA has the base uracil rather than thymine that is present in DNA. RNA is transcribed from DNA by enzymes called RNA polymerases and is generally further processed by other enzymes.

As used herein, the term “RNA polymerase” (RNAP) refers to an enzyme that produces RNA. In cells, RNAP is needed for constructing RNA chains from DNA genes as templates, a process called transcription.

As used herein, the term “5′-end” designates the end of the DNA or RNA strand that has the fifth carbon in the sugar-ring of the deoxyribose or ribose at its terminus.

The genomes of complex organisms are known to vary in GC content along their length. That is, they vary in the local proportion of the nucleotides G and C, as opposed to the nucleotides A and T. Changes in GC content are often abrupt, producing well-defined regions. Such abrupt changes are referred to herein as “change points.”

As used herein, the term “metastructure” refers to the components of a genome, such as, but not limited to, promoters, transcription start (TSSs) and termination sites, open reading frames (ORFs), regulatory noncoding regions (RNRs), untranslated regions (UTRs) and transcription units (TUs) of an organism of interest.

As used herein, an “open reading frame” (ORF) refers to a portion of an organism's genome which contains a sequence of bases that could potentially encode a protein. The start and stop ends of the ORF are not equivalent to the ends of the mRNA, but they are usually contained within the mRNA. In a “gene”, ORFs are located between the start-code sequence (initiation codon) and the stop-code sequence (termination codon).

As used herein, a “transcription unit” (TU) refers to a stretch of DNA, which consists of a promoter site, 5′ untranslated (5′-UTR) sequence, a transcription terminator, 3′ untranslated (3′-UTR) sequence, and the stretch of DNA, which can be transcribed into an RNA molecule (can be mRNA, tRNA, rRNA, miscellaneous RNA). A gene or operon can be controlled by different promoters, hence, resulting in different TUs. Also, the operon length may vary depending on the transcriptional termination signal, yielding in different TUs.

As used herein, a “transcription start site” (TSS) refers to the genomic position where transcription begins. Primer extension can be used to determine the start site of RNA transcription for a known gene. This technique requires a radiolabelled primer (usually 20-50 nucleotides in length) which is complementary to a region near the 5′ end of the gene. The primer is allowed to anneal to the RNA and reverse transcriptase is used to synthesize complementary cDNA to the RNA until it reaches the 5′ end of the RNA. By running the product on a polyacrylamide gel, it is possible to determine the TSS, as the length of the sequence on the gel represents the distance from the start site to the radiolabelled primer. Transcription ends one nucleotide before the start codon (usually AUG) of the coding region. Such positions defining the region of transcription is referred to as the “transcription boundaries.”

As used herein, the term “re-sequencing” or “resequencing” refers to a technique that determines the sequence of a genome of an organism using a reference sequence that has already been completely determined. It should be understood that resequencing may be performed on both the entire genome of an organism or a portion of the genome large enough to include the genetic change of the organism as a result of selection.

As used herein, the term “genetic material” refers to the DNA within an organism that is passed along from one generation to the next. Normally, genetic material refers to the genome of an organism. Extra-chromosomal, such as organelle or plasmid DNA, can also be a part of the ‘genetic material’ that determines organism properties. As used herein, “regulatory region,” when used in reference to a gene or genome, refers to a DNA sequence that controls gene expression. As used herein, a “gene product” refers to biochemical material, either RNA or protein, resulting from expression of a gene. Thus, a measurement of the amount of gene product is sometimes used to infer how active a gene is.

As used herein, the term “genetic change” or “genetic adaptation” refers to one or more mutations within the genome of an organism. As used herein, the term “mutation” refers to a difference in the sequence of DNA nucleotides of two related organisms, including substitutions, deletions, insertions and rearrangements, or motion of mobile genetic elements, for example. The term “introduction,” as used herein, refers to the putting of something such as a genetic change into something else, such as an organism. As such, the term “mutagenesis” is intended to mean the introduction of genetic change(s) into an organism.

The terms “polypeptide,” “peptide” and “protein” are used interchangeably herein to refer to two or more amino acid residues joined to each other by peptide bonds or modified peptide bonds. The terms apply to amino acid polymers in which one or more amino acid residue is an artificial chemical mimetic of a corresponding naturally occurring amino acid, as well as to naturally occurring amino acid polymers, those containing modified residues, and non-naturally occurring amino acid polymer. “Polypeptide” refers to both short chains, commonly referred to as peptides, oligopeptides or oligomers, and to longer chains, generally referred to as proteins. Polypeptides may contain amino acids other than the 20 gene-encoded amino acids. Likewise, “protein” refers to at least two covalently attached amino acids, which includes proteins, polypeptides, oligopeptides and peptides. A protein may be made up of naturally occurring amino acids and peptide bonds, or synthetic peptidomimetic structures. Thus “amino acid”, or “peptide residue”, as used herein means both naturally occurring and synthetic amino acids. For example, homo-phenylalanine, citrulline and noreleucine are considered amino acids for the purposes of the invention. “Amino acid” also includes imino acid residues such as proline and hydroxyproline. The side chains may be in either the (R) or the (S) configuration. Thus, the term “proteomics,” as used herein, refers to the large-scale study of proteins, particularly their structures and functions.

As used herein, the term “mass spectrometry” refers to an analytical technique that measures the mass-to-charge ratio of charged particles. Exemplary uses for the technique include, but are not limited to, determining masses of particles, determining the elemental composition of a sample or molecule, and elucidating the chemical structures of molecules, such as peptides and other chemical compounds. In principle, the technique consists of ionizing chemical compounds to generate charged molecules or molecule fragments and measurement of their mass-to-charge ratios.

As used herein, the terms “ChIP-on-chip” or “ChIP-chip” refer to a technique that combines chromatin immunoprecipitation (“ChIP”) with microarray technology (“chip”). Like regular ChIP, ChIP-on-chip is used to investigate interactions between proteins and DNA in vivo. Specifically, it allows the identification of the cistrome, sum of binding sites, for DNA-binding proteins on a genome-wide basis. Whole-genome analysis can be performed to determine the locations of binding sites for almost any protein of interest.

As used herein, the term “tiling array” refers to a subtype of a microarray wherein probes are short fragments that are designed to cover the entire genome or contiguous regions of the genome. Depending on the probe lengths and spacing, different degrees of resolution can be achieved. The number of features on a single array can range from 10,000 to greater than 6,000,000, with each feature containing millions of copies of one probe. Traditional DNA microarrays designed to look at gene expression use a few probes for each known or predicted gene. In contrast, tiling arrays can produce an unbiased look at gene expression because previously unidentified genes can still be incorporated.

As used herein, the term “deep sequencing” refers to the next-generation of sequencing technologies that generate huge numbers of sequencing reads per experiment or instrument run. These sequencing-based approaches have some distinct advantages over microarray-based approaches for genome-wide transcriptomics (the study of gene expression) and epigenomics (the study of chromatin organization and dynamics), such as avoiding complex intermediate cloning and microarray construction steps and the ability to generate a massive amount of sequence quickly. Using these approaches, gene expression is assayed by directly sequencing cDNA molecules obtained from an mRNA sample and simply counting the number of molecules corresponding to each gene to assess transcript abundance. Exemplary techniques included within the term “deep sequencing” include, but are not limited to, massively parallel signature sequencing (MPSS), sequencing by synthesis (SBS), 454 Life Sciences' SBS pyrosequencing method, Applied Biosystems' SOLiD sequencing by ligation system, and Helicos Biosciences' single-molecule synthesis platform.

As used herein, the terms “selected environment,” “condition” or “conditions” refer to any external property that causes an organism to genetically adapt, evolve, change or mutate for survival. Exemplary “conditions” or “environments” include, but are not limited to, a particular medium, volume, vessel, temperature, mixing, aeration, gravity, electromagnetic field, cell density, pH, nutrients, phosphate source, nitrogen source, symbiosis with one or more organisms, and interaction with a single species of organism or multiple species of organisms (i.e., a mixed population). Also included as “conditions” or “environments” are substances that are toxic to the organism, such as heavy metals, antibiotics and chlorinated compounds. It should be understood that time may also be considered a “condition” since organisms are not static entities. Thus, a culture grown over an extended period of time (e.g., days, weeks, months, years) may produce different strains over the course of its genetic adaptation. An exemplary period of time is 4 to 180 days.

As used herein, the term “clone” refers to a single cell or population of cells that originated from a single cell. A clone is known to consist of cells with only one genotype or to have had a single genotype previously. The term “population” is intended to mean a group of individuals or cells. A “mixed population” therefore refers a group of cells from multiple species or to the collective genomes of naturally occurring organisms.

As used herein, the term “medium” or “media” refers to the chemical environment to which an organism is subjected or is provided access. The organism may either be immersed within the media or be within physical proximity thereto. Media are typically composed of water with other additional nutrients and/or chemicals that may contribute to the growth or maintenance of an organism. The ingredients may be purified chemicals (i.e., “defined” media) or complex, uncharacterized mixtures of chemicals such as extracts made from milk or blood. Standardized media are widely used in laboratories. Examples of media for the growth of bacteria include, but are not limited to, LB and M9 minimal medium. The term “minimal” when used in reference to media refers to media that support the growth of an organism, but are composed of only the simplest possible chemical compounds. For example, M9 minimal medium is composed of the following ingredients dissolved in water and sterilized: 48 mM Na₂HPO₄, 22 mM KH₂PO₄, 9 mM NaCl, 19 mM NH₄Cl, 2 mM MgSO₄, 0.1 mM CaCl₂, 0.2% carbon and energy source (e.g., glucose).

As used herein, the term “culture” refers to medium in a container or enclosure with at least one cell or individual of a viable organism, usually a medium in which that organism can grow. As used herein, the term “continuous culture” is intended to mean a liquid culture into which new medium is added at some rate equal to the rate at which medium is removed. Conversely, a “batch culture,” as used herein, is intended to mean a culture of a fixed size or volume to which new media is not added or removed.

The term “organism” refers both to naturally occurring organisms and to non-naturally occurring organisms, such as genetically modified organisms. An organism can be a virus, a unicellular organism, or a multicellular organism, and can be either a eukaryote or a prokaryote. Further, an organism can be an animal, plant, protist, fungus or bacteria. Exemplary organisms include, but are not limited to bacterial organisms, which include a large group of single-celled, prokaryote microorganisms, and archeal organisms, which include a group of single-celled microorganisms. Archaea and bacteria are quite similar in size and shape. However, archaea possess genes and several metabolic pathways that are more closely related to those of eukaryotes: notably the enzymes involved in transcription and translation.

As is known in the art, bioinformatic or computational methods are used to find elements on a genomic sequence. However, the algorithms used today are based on information that has been experimentally determined in a reference organism(s). The output from the execution of such algorithms is thus a prediction based on extrapolation of information from one or more reference genomes. Since such predictions may or may not be accurate, the determination of the metastructure, as described herein, leads to correction of such potentially inaccurate sequence-based annotations because the information is directly measured and determined for the genome for which the metastructure is built.

Thus, the metastructure for a target bacterial organism is a universal metabolic engineering platform enabling a rational design through optimization of gene and protein expression. The engineered bacterial strains can produce chemical entities of commercial value, which are chemicals, antibiotics, therapeutic proteins, nucleotides and peptides. The systematically designed bacterial strains guided by the metastructure can be optimized by the use of adaptive evolution approach and/or computational optimization procedures (see U.S. Pat. No. 7,127,379, incorporated herein by reference). Furthermore, provided by the present invention is a reporter DNA vector library comprising promoter and reporter gene, wherein each promoter comprises a nucleic acid, whose sequence represents a condition-specific alternative transcription start site and other promoter elements. The reporter system provides a “library kit” to screen novel bacterial strains as the producer of commercially valuable chemical entities.

Accordingly, the present invention provides a method of building a metastructure for a target organism. The method includes iterative integration of multiple genome-scale measurements of RNA polymerase binding locations, mRNA transcript abundance, 5′ sequences and translation into proteins on the basis of genetic information flow to determine the metastructure of a bacterial genome as a universal metabolic engineering platform. In one embodiment, the invention includes obtaining the full genome sequence a target organism, obtaining the genome-wide binding of RNA polymerase from the organism, obtaining the transcription of RNA from the organism, obtaining the 5′ end sequence of the RNA molecules from the organism, obtaining proteomic data from the total protein isolated from the organism, obtaining the data obtained above under a series of culture conditions for the organism, and iteratively mapping the data from the series of culture conditions onto the DNA sequence of the target organism to build the metastructure for the target organism.

The metastructure provides experimentally verified genome-scale transcription units along with alternative TSSs and 5′ UTR and methods to engineer biochemical reaction network of a bacterial cell using them. In both prokaryotic and eukaryotic systems, the level of gene expression is tightly connected to the use of alternative TSSs and the sequence of 5′UTR in the promoter under specific growth conditions. Therefore, the method provided by this invention is to produce tunable (on/off) promoters regulating the level of targeted gene expression to engineer biochemical reaction network using deletion and/or alteration of the selected alternative TSSs and/or 5′UTR of transcription units. Compared to the present invention, the tunable effect can not be produced by the conventional deletion and/or overexpression of the genes in the transcription unit. The modification of the alternative TSSs and/or 5′UTR produces regulatable or tunable promoters of interest.

In general, the regulatable promoters required expensive, toxic or difficult-to-use inducers such as galactose, doxycycline or heat under the targeted growth conditions to produce compounds. Since this invention provides the use of altered native promoters (i.e., deletion or alteration of selected TSSs in the targeted promoter region), the promoter can be controllable by the growth condition of interest. Therefore, the optimal conditions of gene expression can be achieved without additional exogenous inducers.

The engineered strains obtained by the conventional gene deletion and/or overexpression method can be physiologically unstable under multiple conditions due to the loss of conditional essential genes. However, the engineered strains achieved by this invention are remarkably stable, since such conditional essential genes can be expressed through the use of alternative TSSs. Also, the engineered strains can be optimized to the desired performance by culturing the cells for a sufficient period of time so that the strains evolve to. In this way, the physiologically stable bacterial strains expressing the engineered biochemical reaction network can be obtained, which have the regulatable, tunable or controllable promoters. To date, none of systematic use of alternative TSSs at the genome-scale is available for designing novel bacterial strains as the producer of commercially valuable chemical entities.

It has been reported that expression vectors, wherein each vector comprises at least one gene of interest and a promoter operatively linked thereto wherein each promoter comprises a nucleic acid, whose sequence was randomly mutated with respect to that of the wild-type promoter and cells comprising the same. Methods utilizing either the vectors or cells of the invention, in optimizing regulation of gene expression, protein expression, or optimized gene or protein delivery were described (WO 2007/079428 A2; Alper et al. (2005) PNAS, 102, 12678-12683).

Thus, in another aspect the present invention also provides a reporter strain library comprising the vectors. Each vector comprises nucleic acids, whose sequences represent one reporter gene (e.g., fluorescence genes or galactosidase gene), antibiotic resistance genes, multiple cloning sites, and a specific promoter. The promoter contains single alternative TSS and 5′UTR. Each vector in the library provides a desired level of expression of the reporter gene under the targeted culturing conditions. Therefore, strains with higher expression levels of genes of interest are obtained from the vectors under the specific culturing conditions.

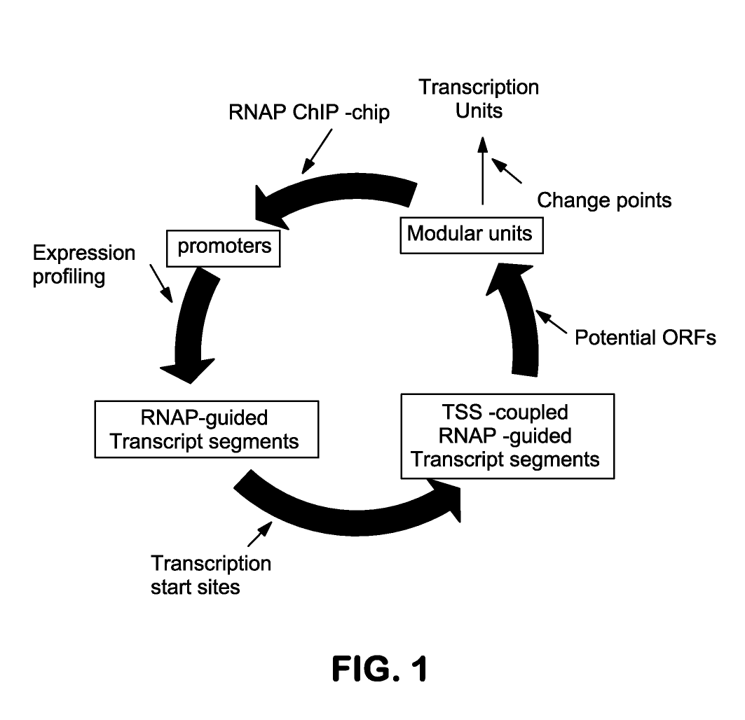

In one aspect of this invention, there is provided a method to integrate multiple high-throughput genome-scale measurements (FIG. 1). Using a method of this aspect of the present invention, genome-scale modular units can be obtained for a specified growth environment.

Another aspect of this invention provides a method to obtain genome-scale TUs. The modular unit is different from the classic definition of an operon, since operons do not allow for nested TUs. Consequently, the TU architectures of bacterial genomes that result from condition-dependent combination of the modular units were determined. In general, a TU in a bacterial genome is defined as having multiple ORFs that are transcribed from one promoter to synthesize a single mRNA transcript. Conceptually, expression levels of multiple modular units within a single TU remain constant without an expression gap between them, assuming an absence of differential mRNA degradation.

Another aspect of this invention provides a method to engineer tunable/controllable/regulatable promoters. Examples of tunable (on/off) promoters regulating the level of targeted gene expression are described herein.

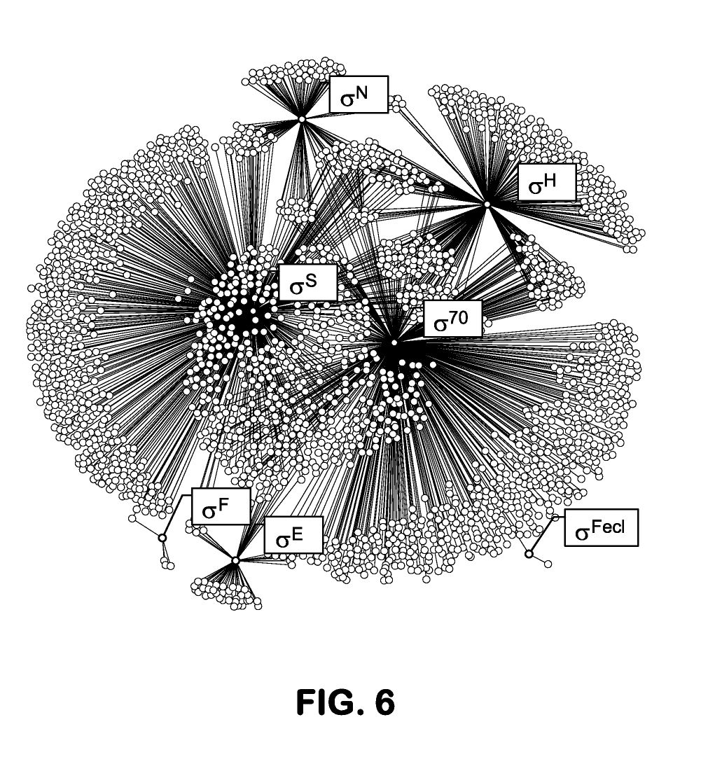

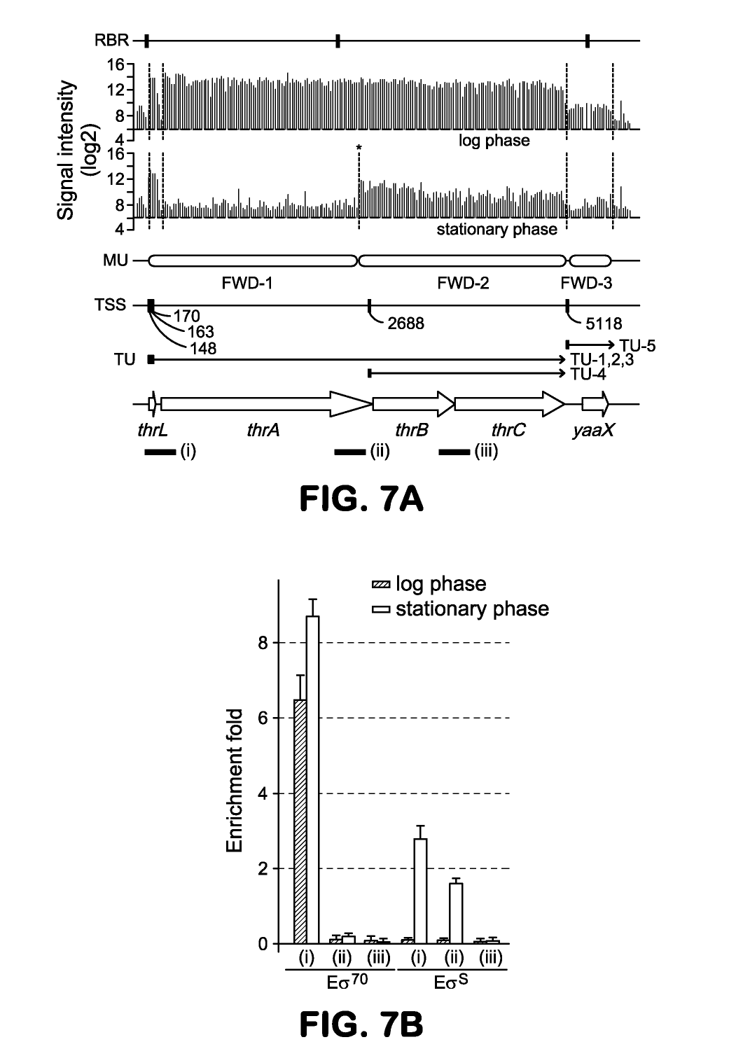

Conditional use of sigma factors—transcription units can be transcribed in a condition-dependent manner through alternative sigma factor use. The genome-scale location map of sigma factors provides basic information to design the tunable/controllable/regulatable promoters. For example, the genome-scale location of all sigma factors in E. coli has been determined in this invention. The number of promoters found in this invention are 1,527 (rpoD), 1,364 (rpoS), 539 (rpoH), 161 (rpoN), 64 (rpoE), 78 (fliA), and 2 (fecI) (FIG. 6). For example, the thrLABC operon is regulated by transcriptional attenuation, which is modulated by the availability of charged isoleucyl- and threonyl-tRNA. However, additional promoter that found by this invention is located in front of thrB separately regulate thrBC under stationary growth phase. The promoter is conditionally activated by σ^{S} holoenzyme under stationary growth phase (FIG. 7). Based on this finding, the native tunable/controllable/regulatable promoters working under six conditions (log, stationary, mild heat-shocked, extreme heat-shocked, glutamine, and iron conditions) can be designed.

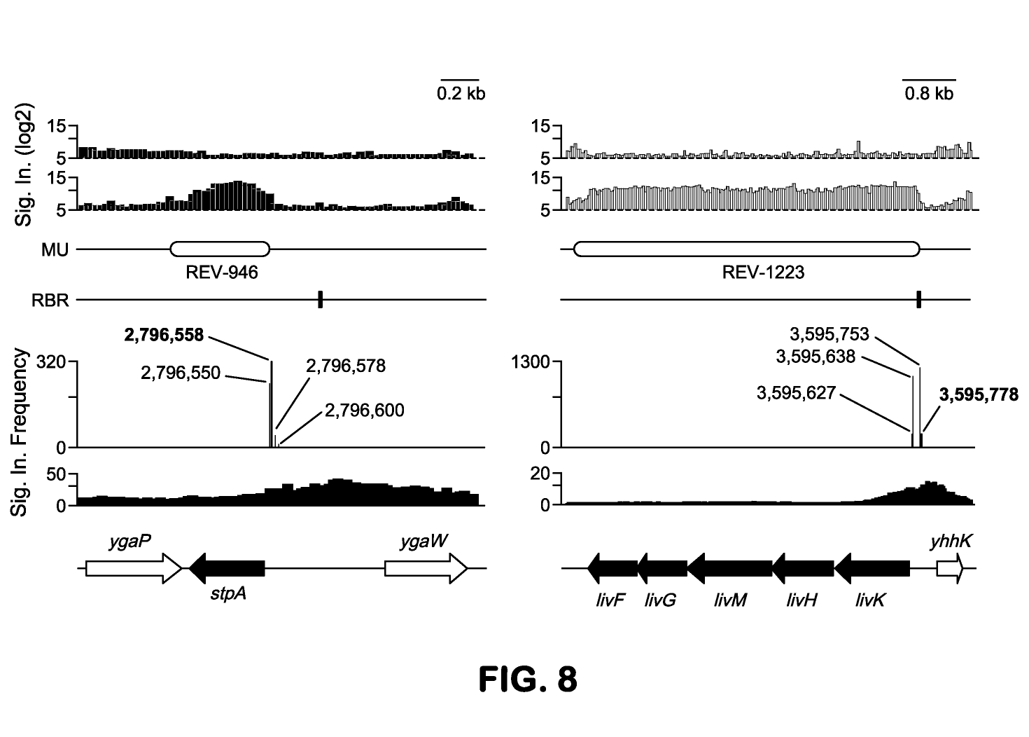

Conditional use of alternative TSSs—transcription units can be transcribed in a condition-dependent manner through alternative TSS use. The use of alternative TSS can be determined by the novel 5′-RACE-seq method using a unique RNA adapter and massive-scale sequencing. For example, 4,133 TSSs were determined in E. coli genome. 35% of promoters contain multiple TSSs, representing the presence of alternative TSSs for large portions of the E. coli transcription units. For example, the stpA gene and the livKHMGF operon encoding an H-NS-like DNA-binding protein and the leucine ABC transporter complex both have multiple experimentally verified TSSs. In the case of the stpA promoter, the dominant TSS (2,796,558) was detected, which is highly activated by the transcription factor Lrp. The two other TSSs (2,796,578 and 2,796,600) are therefore likely to be less utilized under the growth conditions. On the other hand, two confirmed TSSs were observed from the promoter region of livKHMGF operon. While the TSS (3,595,753) is dominantly utilized to transcribe the operon, the transcription factor Lrp apparently represses the other TSS (3,595,778) (FIG. 8). Based on this finding, the native tunable/controllable/regulatable promoters working under three conditions (log, stationary, and mild heat-shocked conditions) can be designed using deletion and/or alteration of the selected alternative TSSs.

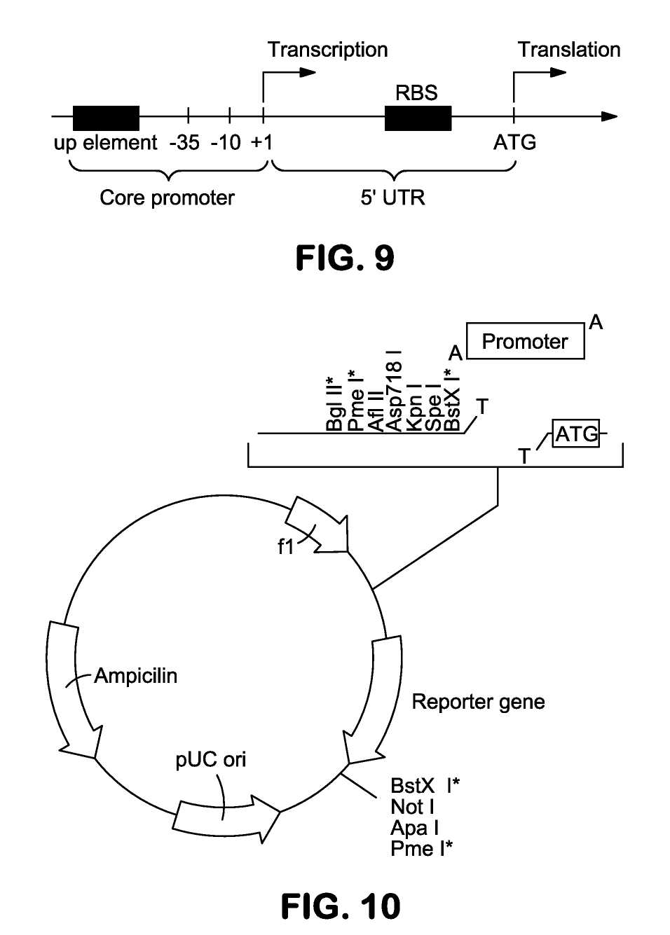

Use of 5′UTR—5′UTR regions were defined as DNA sequences between each TSS and translation start site of the first gene in the transcription unit (FIG. 9). The native tunable/controllable/regulatable promoters can be designed using deletion and/or alteration of the 5′UTR sequences. For example, the median length of E. coli 5′UTR was around 36 bp. The majority of TSSs (˜93%) fall within 300 bp from the translation start site. Another aspect of this invention provides the core promoter elements (e.g., −10 (or extended −10), −35, and a spacer region) at the genome-scale, which can be used to design the promoters.

Another aspect of this invention provides a reporter vector library to obtain optimal uses of alternative sigma factors, alternative TSSs or 5′UTR for the desired levels of expression of the targeted genes.

Construction of the vectors—Each vector comprises at least one reporter gene (e.g., green fluorescence protein, lacZ, etc), antibiotics gene (ampicillin, kanamycin, or chloramphenicol resistance), replication origin, T7 priming site and a promoter operatively linked thereto, wherein each promoter comprises nucleic acids, whose sequences are amplified from native promoter (FIG. 10). The promoter sequence is a DNA sequence which is important for transcription of gene (or transcription unit) under the appropriate conditions. The promoter sequence can be mutated by site-directed mutagenesis to represent single transcription start site and 5′UTR in each vector. The vector library can be derived from information on alternative sigma factors, alternative TSSs or 5′UTR from Escherichia, Salmonella, Bacillus, Pseudomonas, Helicobacter, Streptomyces, Streptococcus, Lactobacillus, Geobacter, Thermotoga, Vibrio, Yersinia or other prokaryotic cells. For example, at least 4,661 vectors can be constructed from E. coli sigma factors, transcription start sites and 5′UTR information described here.

Evaluation of the vectors—Each vector can be evaluated for its promoter strength and translation efficiency under certain culture conditions, in terms of the resulting levels of messenger RNAs and proteins of the reporter gene. The culture conditions can be oxygen levels, nutrient levels, temperature, pressure, light, metals, other chemicals, or other environmental stimuli. The levels of messenger RNAs of the reporter gene can be measured by quantitative PCR (qPCR), oligonucleotide microarray platforms, microfluidic platforms, Sanger sequencing platforms, or massive-scale sequencing platforms. The translation level of the reporter gene can be measured by fluorescence level or β-galactosidase activity. Based on the evaluation of promoter strength and translation efficiency under certain culture conditions, the tunable/controllable/regulatable conditions can be determined.

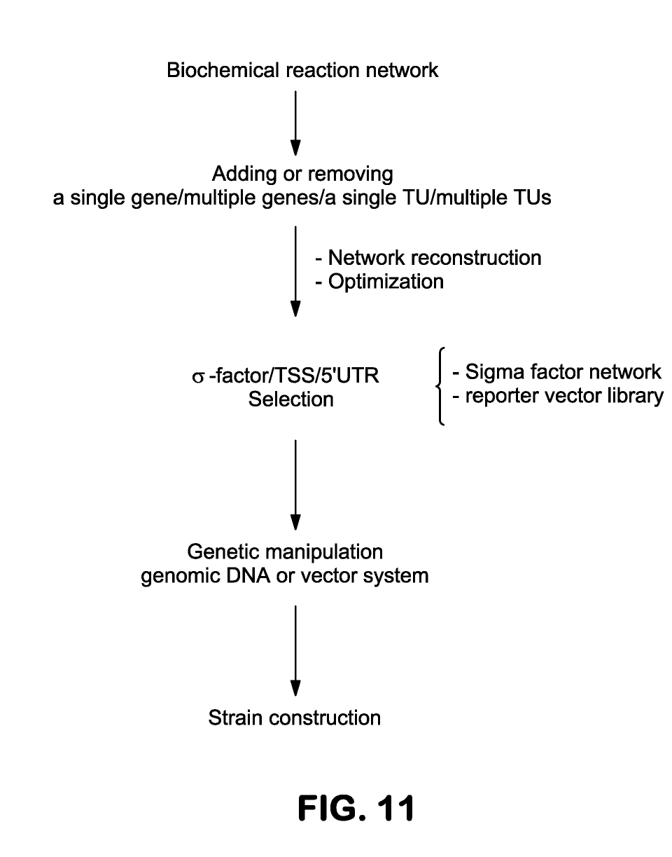

Another aspect of this invention provides a method to engineer biochemical reaction network using the tunable/controllable/regulatable promoters (i.e., use of the sigma factors, alternative TSSs, or 5′UTR sequences). Examples of use of the sigma factors, alternative TSSs or 5′UTR sequences to engineer biochemical reaction network of a bacterial cell are described herein (see FIG. 11).

Selection of genes or transcription units in the biochemical reaction network—the performance of biochemical reaction network is often dependent on the expression level of several genes within the network. Using the optimization methods, the optimal or suboptimal functionalities of the biochemical reaction network can be determined under certain culture conditions. By removing or adding a single gene, multiple genes, a single transcription unit, or multiple transcription units, the biochemical reaction network can be reconstructed. Using the same optimization methods, the optimal or suboptimal properties of the biochemical reaction network can be recalculated. The sets of genes or transcription units which change the biochemical reaction network toward optimal or suboptimal point can be selected from the recalculation.

Selection of sigma factors, TSSs or 5′UTR sequences—from the sigma factor interaction network, the house-keeping sigma factor or alternative sigma factors can be selected for obtaining the optimal or suboptimal biochemical reaction network properties. From the reporter vector library, the alternative TSSs or 5′UTR sequences can be selected for obtaining the optimal or suboptimal biochemical reaction network properties. Using the selected sigma factors, TSSs or 5′UTR sequences, the native promoters of the selected genes or transcription units in the genome can be genetically manipulated. Alternatively, instead of the manipulation of native genome, the vectors comprising alternative TSSs and 5′UTR sequences can be used to achieve the optimal or suboptimal biochemical reaction properties.

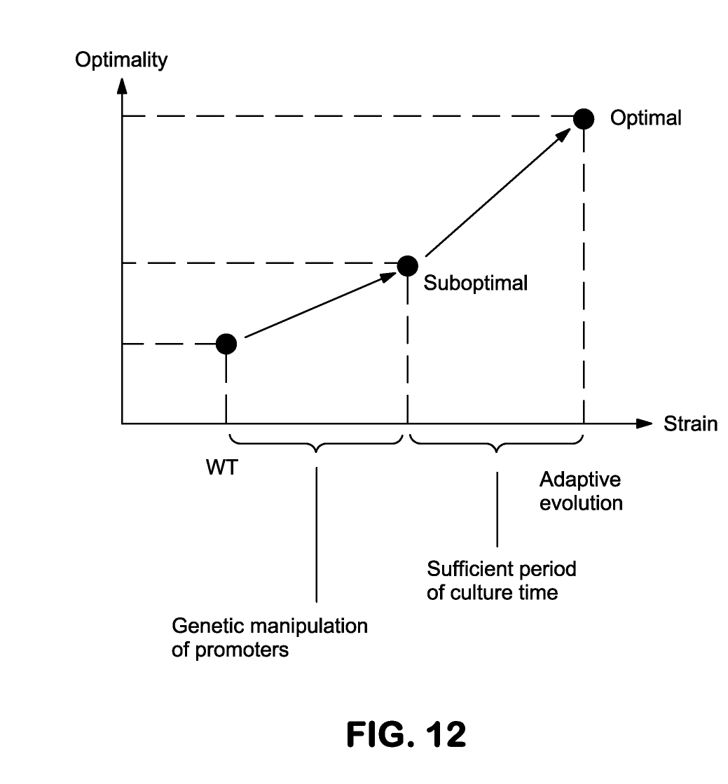

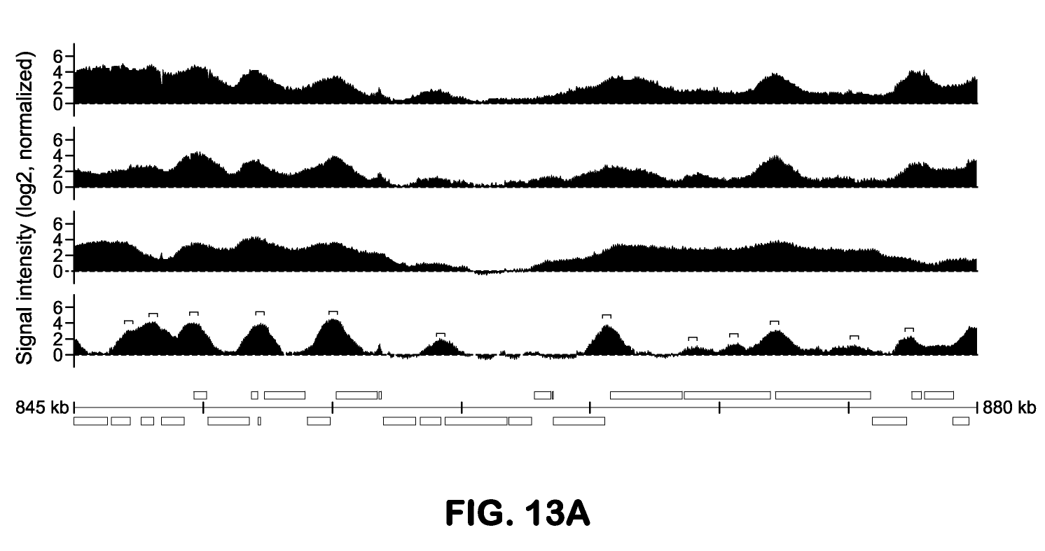

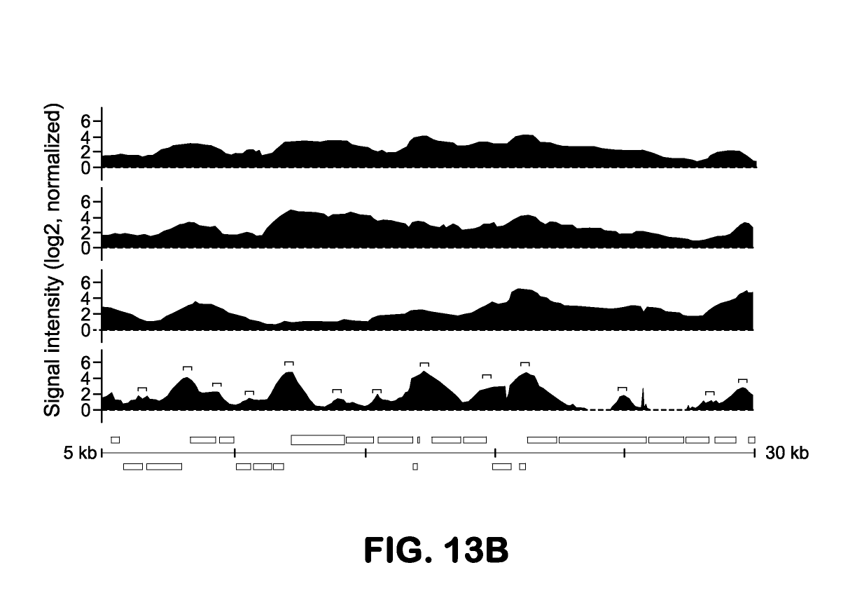

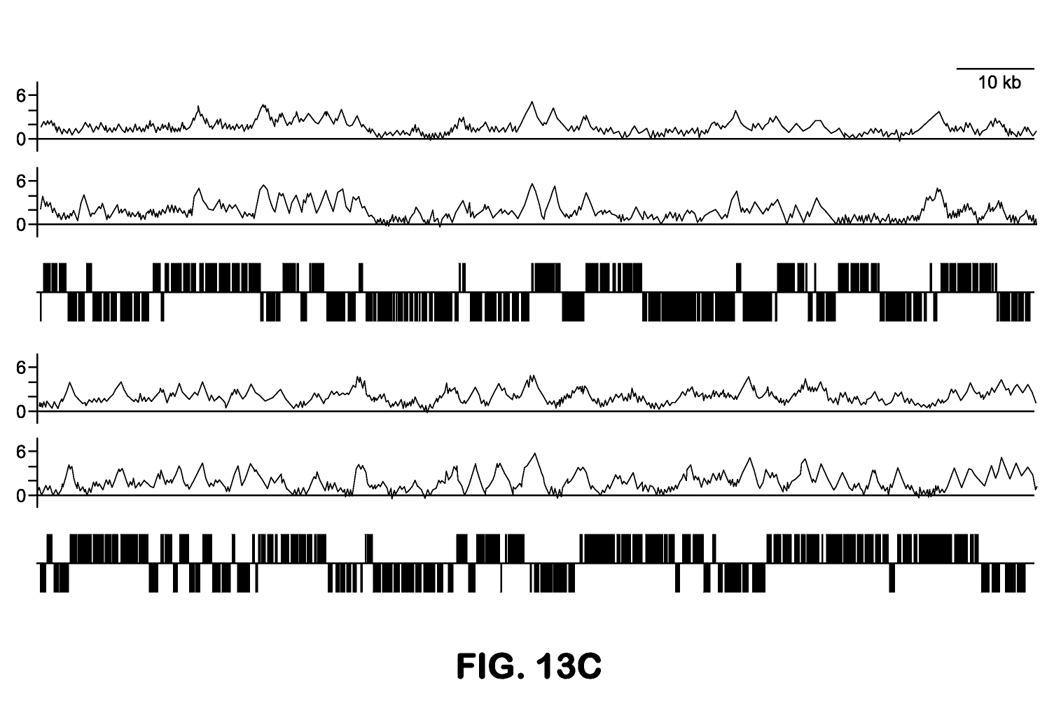

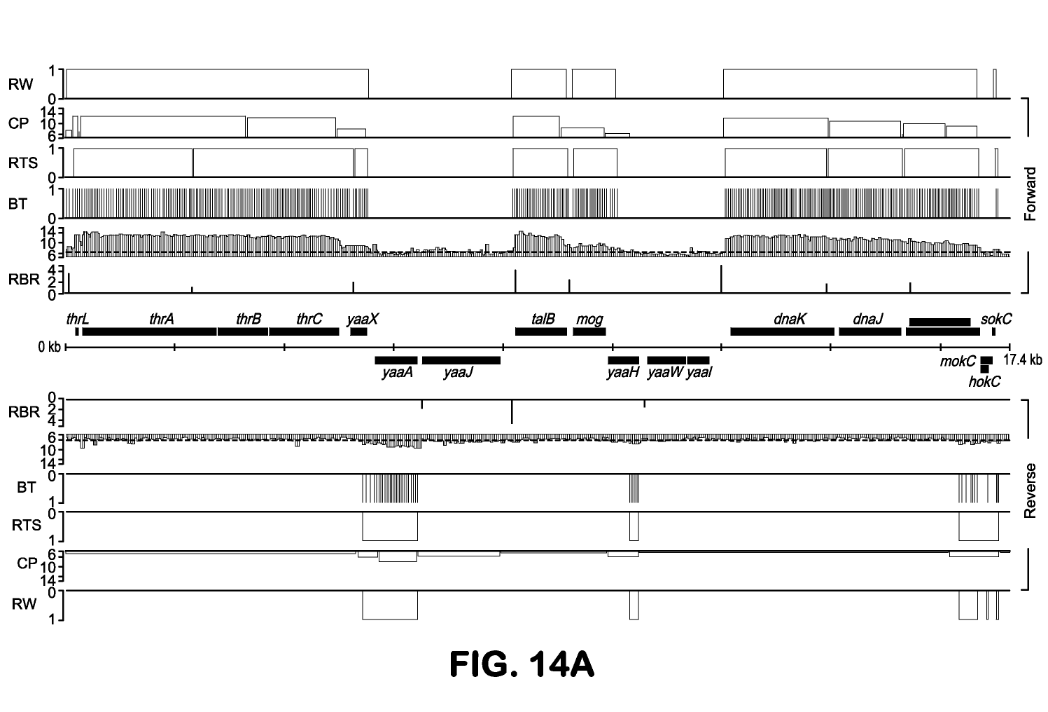

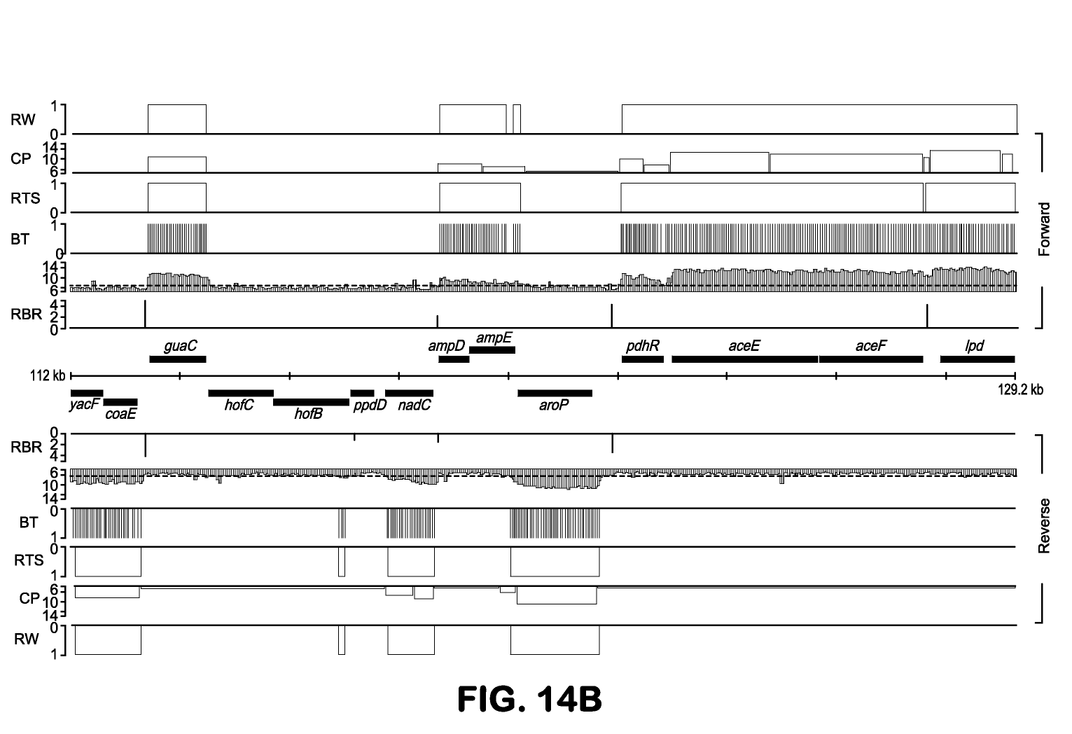

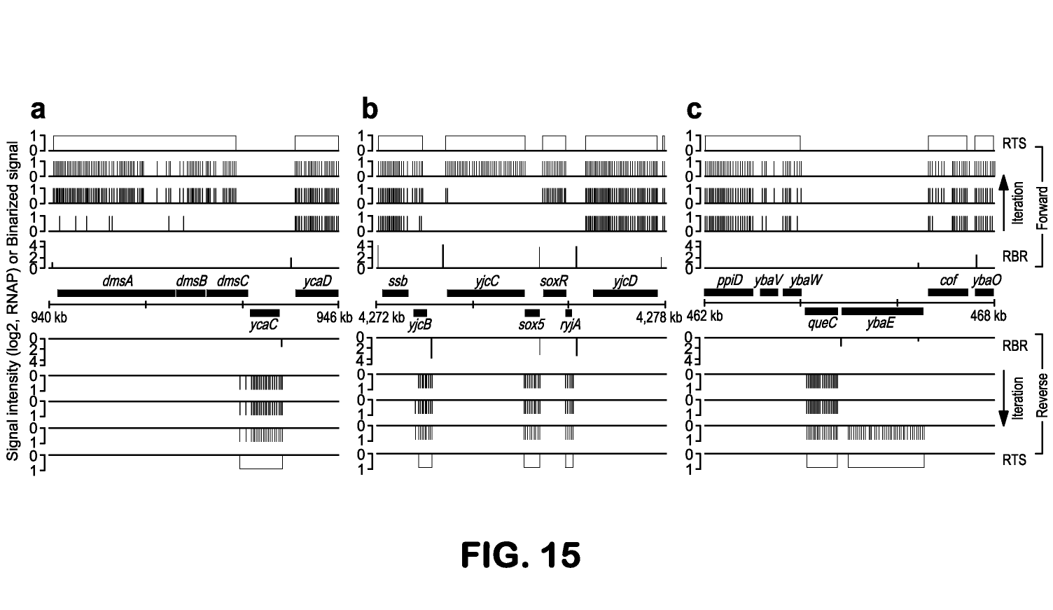

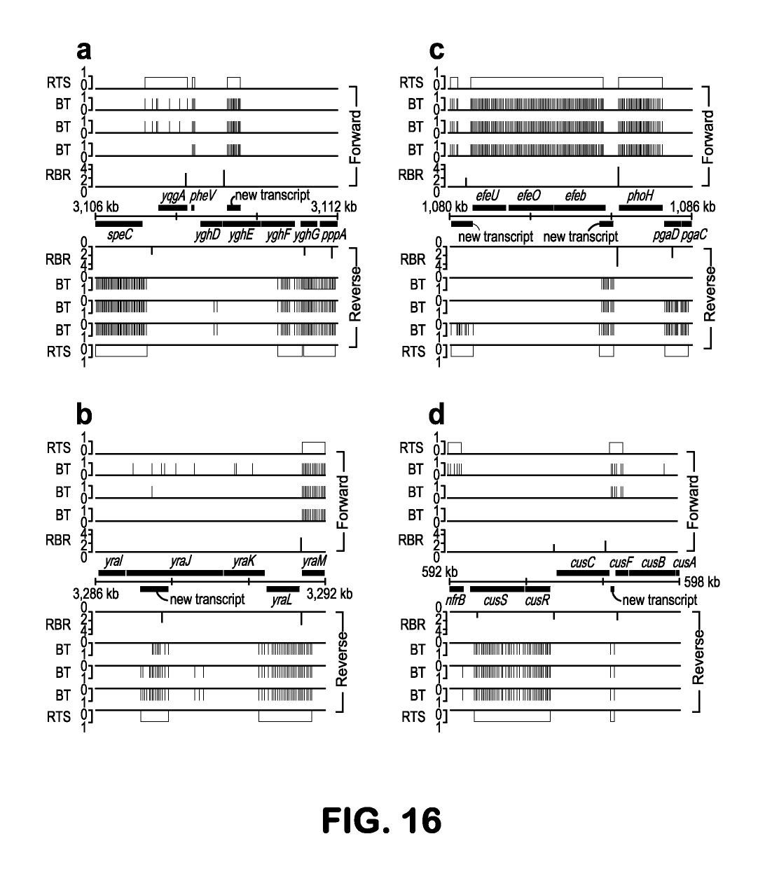

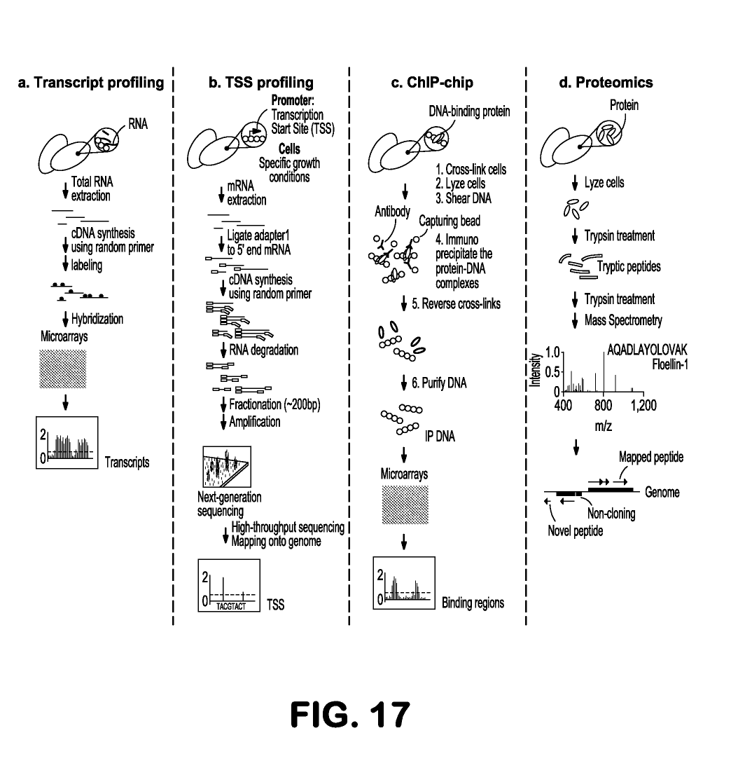

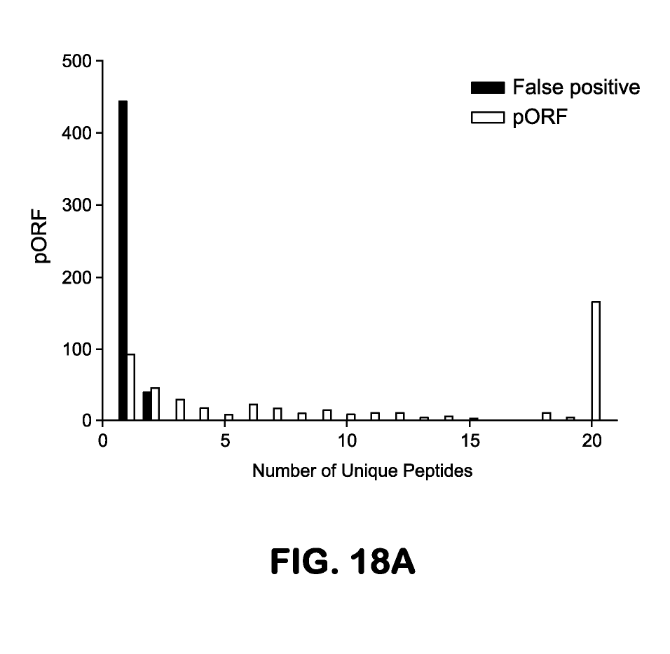

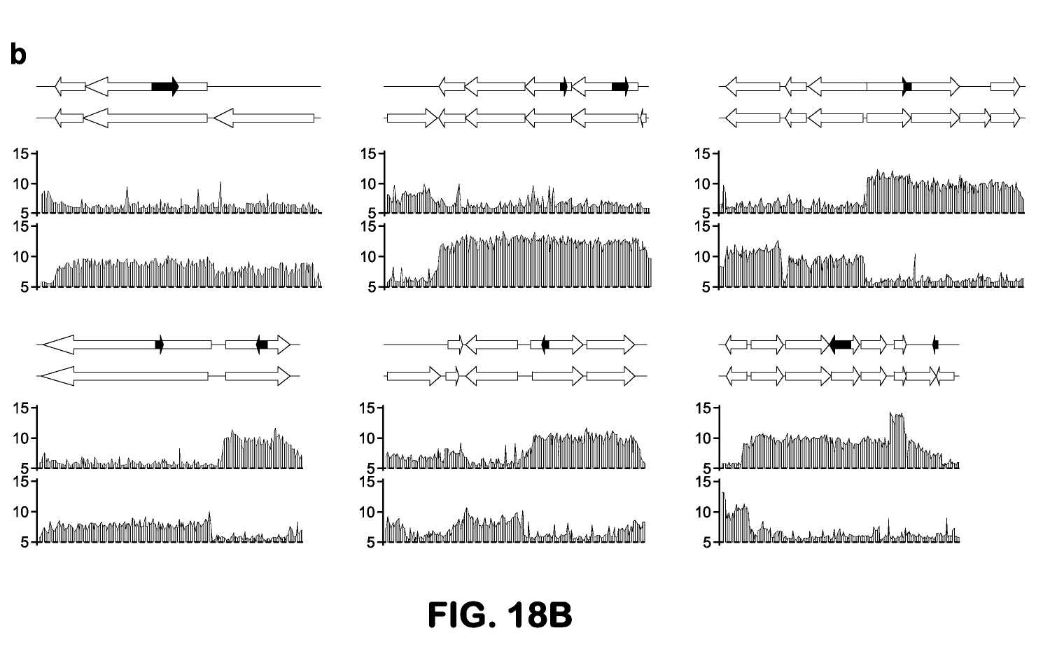

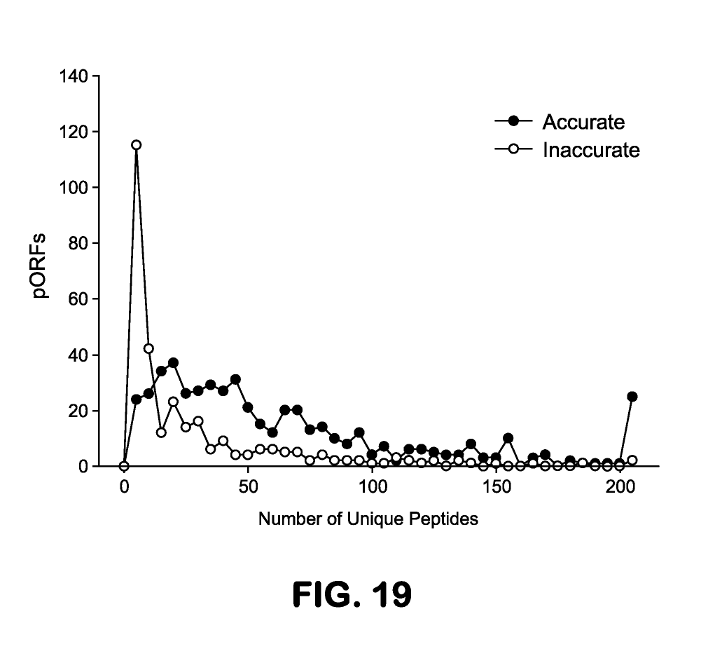

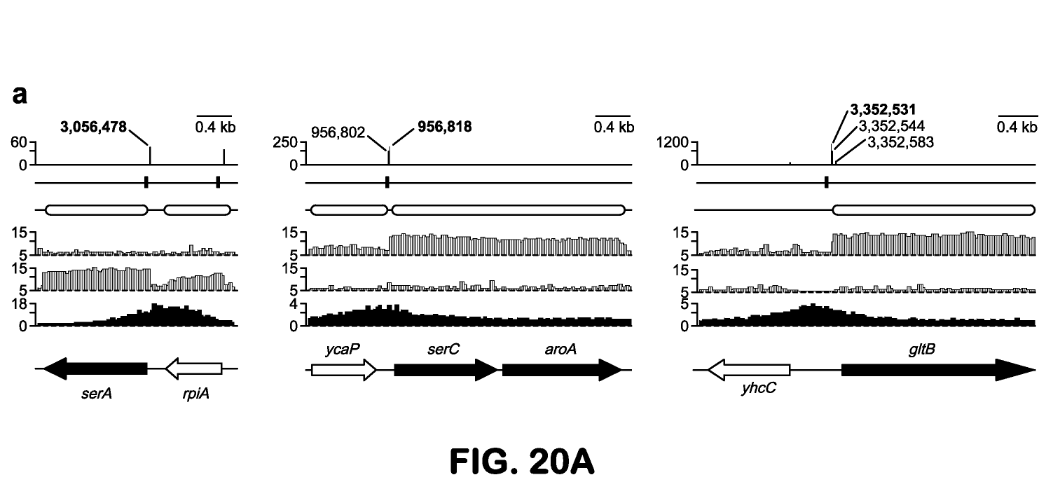

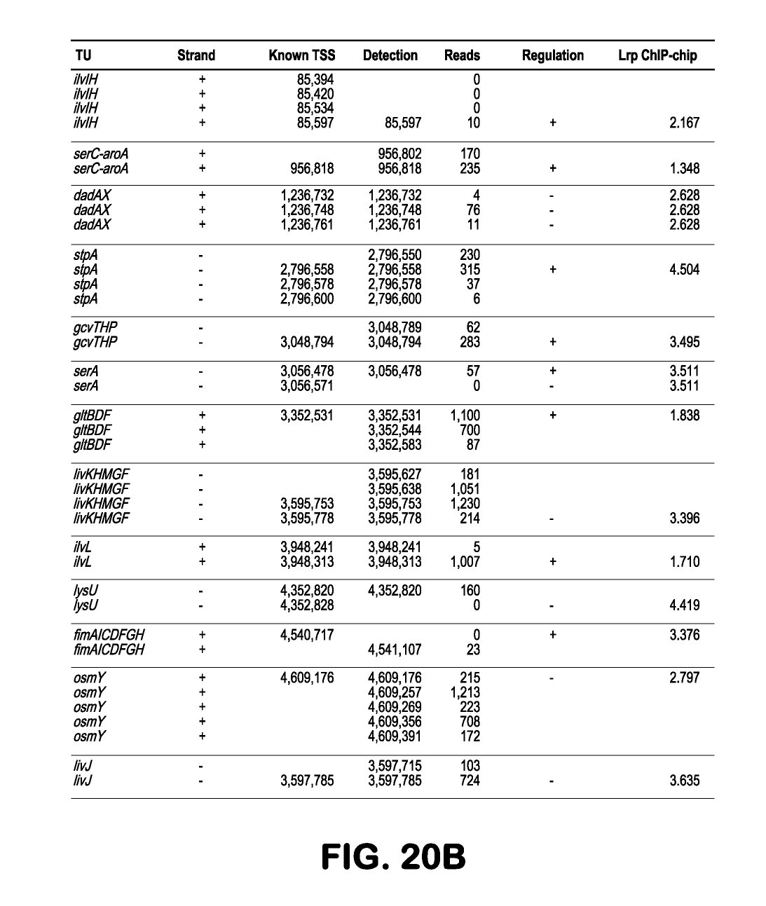

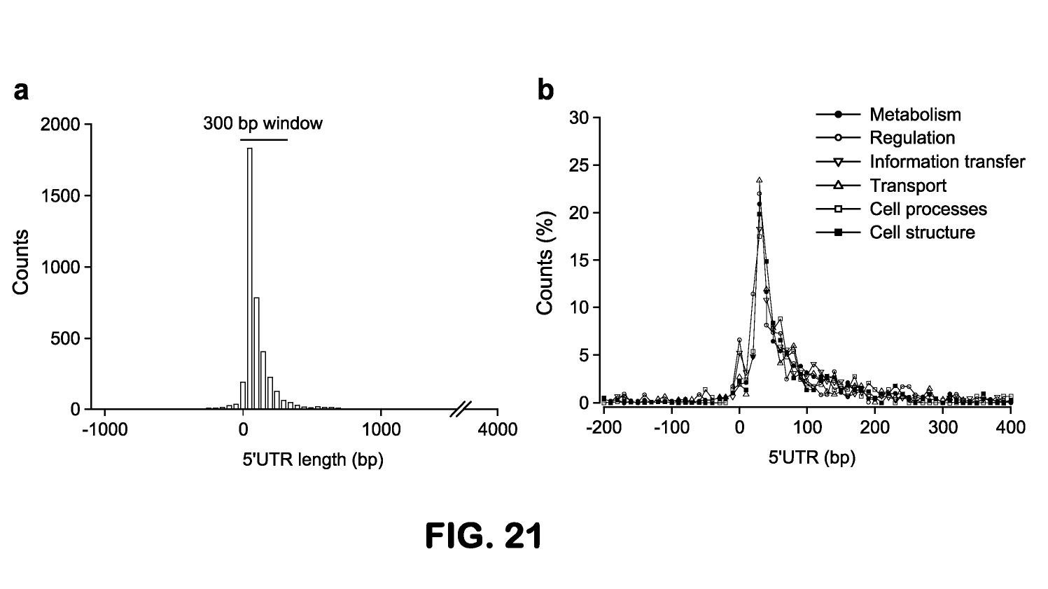

Another aspect of this invention provides a method to optimize the engineered strain to the desired performance using growing the cells in certain period of time (FIG. 12). Cultivating the cells for a sufficient period of time under conditions allows the cells to evolve to the desired performance. Since this adaptive evolution process may itself determine the best set of kinetic parameters to achieve the optimal design, the use of tunable/controllable/regulatable promoters will accelerate the adaptive evolution process.

The following examples are intended to illustrate but not limit the invention.

### EXAMPLE 1

### Metastructure Determination

This example demonstrates the detailed procedures used by describing how a specific situation is processed.

Strains and Media—E. coli MG1655 cells were harvested at mid-exponential phase (OD_{600 nm}˜0.6) with exception of stationary phase experiments (OD_{600 nm}˜1.5). Glycerol stocks of E. coli strains were inoculated into M9 complete or W2 minimal medium (for nitrogen-limiting condition) and cultured at 37° C. with constant agitation overnight. Cultures were diluted 1:100 into fresh minimal medium and then cultured at 37° C. to appropriate cell density. For heat-shocked experiments, cells were grown to mid-exponential phase at 37° C. and half of the culture was sampled for as a control. The remaining culture was transferred into pre-warmed (50° C.) medium and incubated for 10 min. For nitrogen-limiting condition, ammonium chloride in the minimal medium was replaced by glutamine (2 g/L). For rifampicin-treated cells, rifampicin dissolved in methanol was added to a final concentration of 150 μg/mL and subsequently stirred for 20 min. Cultures were monitored by observing cell density at 600 nm to verify inhibitory effects of rifampicin.

ChIP-chip—Cells at appropriate cell density were cross-linked by 1% formaldehyde at room temperature for 25 min. Following quenching the unused formaldehyde with a final concentration of 125 mM glycine at room temperature for 5 min, the cross-linked cells were harvested and washed three times with 50 mL of ice-cold TBS (Tris Buffered Saline). The washed cells were re-suspended in 0.5 mL lysis buffer composed of 50 mM Tris-HCl (pH 7.5), 100 mM NaCl, 1 mM EDTA, 1 μg/mL RNaseA, protease inhibitor cocktail (Sigma) and 1 kU Ready-Lyse™ lysozyme (Epicentre). The cells were incubated at room temperature for 30 min and then treated with 0.5 mL of 2×IP buffer with the protease inhibitor cocktail. The lysate was then sonicated four times for 20 sec each in an ice bath to fragment the chromatin complexes using a Misonix sonicator 3000 (output level=2.5). The range of the DNA size resulting from the sonication procedure was 300-1000 bp. 6 ρL of mouse antibody (NT63, Neoclone) was used to immunoprecipitate the chromatin complex of RNA polymerase β subunit (RpoB) and DNA. For the control (mock-IP), 2 μg of normal mouse IgG (Upstate) was added into the cell extract. The remaining ChIP-chip procedures were performed as described previously. The high-density oligonucleotide tiling arrays used to perform ChIP-chip analysis consisted of 371,034 oligonucleotide probes spaced 25 bp apart (25 bp overlap between two probes) across the E. coli genome (NimbleGen). After hybridization and washing steps, the arrays were scanned on an Axon GenePix 4000B scanner and features were extracted as a pair format by using NimbleScan™ 2.4 software (NimbleGen).

qPCR—To monitor the enrichment of RNAP-binding regions prior to the microarray hybridization, the quantitative real-time PCR (qPCR) against the previously characterized RNAP-binding regions was performed in triplicate using iCycler™ (Bio-Rad) and SYBR green (Qiagen). The qPCR conditions were as following: 25 μL SYBR, 1 μL of each primer (10 pM), 1 μL of IP or mock-IP DNA, and 22 μL of ddH₂O. The samples were cycled to 94° C. for 15 sec, 52° C. for 30 sec, and 72° C. for 30 sec (total 40 cycles) on a LightCycler (Bio-Rad). The threshold cycle (Ct) values were calculated automatically by the iCycler™ iQ optical system software (Bio-Rad). Normalized Ct (ΔCt) values for each sample were calculated by subtracting the Ct value obtained for the mock-IP DNA from the Ct value for the IP-DNA (ΔCt=Ct_{IP}−Ct_{mock}). To measure relative gene expression levels, cDNA synthesized was used instead of the IP DNA.

Identification of RNAP-binding regions—To identify RNAP-binding regions, the peak finding algorithm built into the NimbleScan™ software was used. Processing of ChIP-chip data was performed in three steps: normalization, IP/mock-IP ratio computation (log base 2), and enriched region identification. For normalization and log ratio computation, signal intensity from all arrays was mapped to a reference distribution created by taking averages of the sorted raw data and scaled to a median of one. The ChIP-chip datasets exhibited strong raw reproducibility (pair-wise Pearson coefficients≧0.96). Each log ratio dataset from triplicate samples was used to identify RNAP-binding region using the software (width of sliding window=300 bp). The results from this analysis were not the binding positions (i.e., single binding peaks) but binding regions. The median position of those regions was then calculated to avoid detecting skewed position by unwanted noises. Since the median positions do not necessarily match to the probe positions of the microarray, the nearest probe positions were assigned to the median positions. The approach of identifying the RNAP-binding regions was to first determine binding locations from each data set and then combine the binding locations from at least five of the six datasets to define a binding region. ChIP-chip experiments are usually performed using multiple replicates, and it is common to average these replicates to produce on enrichment signal that is then analyzed for binding event information. It has been observed that different replicates often reflect non-trivial differences in molecular binding activity and that averaging can abolish strong enrichment signals or indicate binding event locations that are not supported by any individual replicate. So, after normalizing replicates first individually and then altogether, a baseline correction was computed and applied in the form of an offset for each replicate such that an enrichment signal of one corresponded to the mean value of the non-enriched probes. All raw and processed signals, along with in-house Perl and R scripts used to process raw ChIP-chip datasets, are available from online at: systemsbiology.ucsd.edu/publications.

Transcriptome analysis—Total RNA samples were isolated using RNeasy Plus Mini kit (Qiagen) in accordance with manufacturer's instruction. Subsequently, 20 μg of the purified total RNA sample was reverse transcribed with 1,500 U SuperScript II reverse transcriptase (Invitrogen), 30 U SUPERase.In (Ambion), 750 ng random primer, 10 mM dNTP mixture containing 4 mM amino-allyl dUTP, 10 mM DTT and 8 μg/mL actinomycin D. Actinomycin D was used to remove antisense transcript artefacts during the cDNA synthesis. The amino-allyl labeled cDNAs were purified with QIAquick PCR purification columns (Qiagen). Phosphate wash (5 mM KPO₄ and 80% ethanol) and elution buffer (4 mM KPO₄) were used to protect amino-allyl residues instead of using PE and PB buffers, respectively. The amino-ally labeled cDNAs were subsequently incubated with Cy5 Monoreactive dyes (Amersham) to obtain Cy5 labeled cDNAs. The cDNA samples were fragmented by 0.3 U RNase-free DNaseI (Epicentre) per μg cDNA, which were then purified and hybridized onto the high-density oligonucleotide tiling microarrays. After hybridization and washing steps, the arrays were scanned on an Axon GenePix 4000B scanner and features were extracted by using NimbleScan software. The resulting pair files from experimental triplicates were then normalized using the ‘Robust Multichip Average analysis’ (RMA analysis) function from NimbleScan.

Determination of RNAP-guided transcript segments—Following the normalization, the ‘TranscriptionDetector’ algorithm (TD) was employed to determine probes expressed above background level. To determine the background level, negative control probes that represent non-specific background hybridization were selected to evaluate the significance of expression of individual probes (p-value calculation). The negative control probes were randomly selected based on the median signal intensity. The purpose of negative control probes is to estimate the background, non-binding probe signal. This is because the nucleotide sequence of the negative control probes does not match any region of the genome, and so no hybridization should occur with the negative control probes. Lacking the negative control probes on the array, it was reasoned that there are probes on the array that effectively act as negative control probes since not all of the genome is expressed in any one condition, and by implication there are probes for which no complementary transcript exists in the cell.

These probes were identified by assuming that more of the genome is not expressed than is expressed in a particular condition. Under this assumption, the median probe value corresponds to a probe with no enrichment. The results changed very little if even lower values for background signal were used, but did change noticeably if (much) higher values were used. These checks indicated that the non-binding probe values had safely been estimated. The microarray signals were transformed to binary absence/presence calls as one (probes expressed above background) and zero (background). However, it was often observed that the orphan presence calls in the binary absence/presence calls obtained from TD algorithm. Since the orphan presence calls are most likely to be false positives from TD algorithm, the orphan calls were manually removed based on the presence calls from the opposite strand (i.e., if there are dense calls from opposite strand, the orphan calls of the strand were removed). Then, genomic coordinates of the first and last presence calls between two RNAP-binding regions were assigned to the start and end genomic coordinates of RNAP-guided transcript segment. However, in some cases, the RNAP-binding regions did not allow us to select correct position of first expressed probes, since the median probe position was assigned to the RNAP-binding region. Therefore, the first probe position was manually assigned to the RNAP-guided transcript segment. A minority (less than 2%) of transcribed regions lacked RNAP-binding regions (a total of 98 RNAP-guided transcript segments). Unlikely long RNAP-guided transcript segments and another RNAP-guided transcript segment at the opposite strand were detected. Without being bound by theory, these cases were considered due to the low gene expression and the failure to detect RNAP-binding regions. Therefore, the RNAP-guided transcript segments were manually divided into two segments. However, it was expected that expression of those regions might increase when different growth conditions are applied. Through implementing a fixed intensity threshold (presence/absence calls) and a genomic coordinate of the RNAP-binding region, genome-wide summary of piece-wise constant expression segments (i.e., RNAP-guided transcript segments) were obtained along with their genomic coordinates and potential promoter regions.

Genome-scale determination of transcription start sites (TSSs)—Total RNA samples were isolated as described above. To enrich mRNA from the isolated total RNA samples, ribosomal RNA (rRNA) was removed by using MICROBExpress™ kit (Ambion) in accordance with manufacturer's instruction. To ligate 5′-RNA adapter (5′-GUUCAGAGAGUUCUACAGUCCGACGAUC) (SEQ ID NO: 1) to the 5′-end of mRNA, the enriched mRNA samples were incubated with 100 μM of the adapter and 4 U of T4 RNA ligase (NEB). cDNAs were then synthesized from the adapter-ligated mRNA samples using random primers extended with 3′-adapter sequence (5′-CAAGCAGAAGACGGCATACGANNNNNNNNN) (SEQ ID NO: 2). The mRNA samples were then reverse transcribed as described above to obtain cDNA samples. The cDNA samples were amplified using a mixture of 1 μL of the cDNA, 10 μL of Phusion HF buffer (NEB), 1 μL of dNTPs (10 mM), 1 μL SYBR green (Qiagen), 0.5 μL of HotStart Phusion (NEB), and 5 pmole of primer mix (5′-CAAGCAGAAGACGGCATACGA (SEQ ID NO: 3) and 5′-AATGATACGGCGACCACCGACAGGTTCAGAGTTCTACAGTCCGA (SEQ ID NO: 4)). The PCR mixture was denatured at 98° C. for 30 sec and cycled to 98° C. for 10 sec, 57° C. for 20 sec and 72° C. for 20 sec. The amplification was monitored on a LightCycler (BioRad) and stopped at the beginning of the saturation point. Fraction of the amplified DNA between 100 bp and 200 bp was then extracted from a 6% TBE gel after electrophoresis. Gel slices were dissolved in two volumes of EB buffer (Qiagen) and 1/10 volume of 3 M sodium acetate (pH 5.2). The amplified DNA was ethanol-precipitated and resuspended in EB buffer. Second PCR amplification was carried out for amplifying the DNA libraries to a total final mass up to 1 μg with as few PCR cycles as possible. The final amplified DNA libraries were purified using QIAquick PCR purification column and eluted in 35 μl EB buffer. The samples were then quantified on a NanoDrop 1000 spectrophotometer.

Sequence data processing and mapping—Since sequence reads obtained from an Illumina Genome Analyzer become more error prone towards the 3′-end, all reads were truncated to 25 bp. These truncated reads were then aligned onto the E. coli MG1655 genome (NC_{—}000913) using BLAT with the following arguments: stepsize=1, tilesize=12, minmatch=1. Only reads that aligned to only one genomic location were retained. Finally, the genomic coordinate of the 5′-end of these uniquely aligned reads were defined as a TSS, which was then mapped onto 5′-end of the RNAP-guided transcript segments with the following criteria: window size=200 bp, cutoff=60%.

Predicting potential ORFs (pORFs) and mapping them onto RNAP-guided transcript segments—Proteomics data, using cells grown under log phase, heat-shocked conditions, and stationary phase, were obtained by using LC-FTICR mass spectrometry as described before. These proteomics data were analyzed by SEQUEST to match MS/MS spectra against the stop-to-stop peptide database. To generate this database, the E. coli genome sequence (NC_{—}000913) was computationally segmented into stop-to-stop fragments considering two adjacent stop codons in all six translational frames and translated into peptides. The peptides were then chunked into 10-mer oligopeptides, retaining genomic position and frame information. The proteomics analysis yielded a total of 54,549 peptides, covering ˜59% of currently annotated ORFs. To predict all potential ORFs (pORF) in the E. coli genome, all stop codons (TAG, TAA, and TGA) across the entire genome were identified and then assigned the first occurring start codon (ATG, GTG, or TTG) between two adjacent stop codons in the same frame (the maximally extendable ORF). This process yielded a total of 156,781 maximally extendable ORFs from 439,680 start codons and 359,212 stop codons in all six translational frames (see, e.g., Table 7 on the world wide web at systemsbiology.ucsd.edu/tables, current as of Oct. 29, 2010, herein incorporated by reference in its entirety). It should be noted that start codon preference and length of the maximally extendable ORF were not considered to generate them. In a functional classification of ORF, the coverage of annotated proteins (˜52%) was higher than of hypothetical proteins (˜35%). At the end, the maximally extendable ORFs containing at least one peptide (in frame) from proteomics data (from this study and publicly available source) were considered as preliminary pORFs. A total of 131 peptides (˜0.3%) were removed because they did not map to any maximally extendable ORFs. Although the 131 peptides were obtained as unique ones from the mass spectrometry analysis, the existence of false positives in the unique peptides should be considered. Therefore, the difference between the filtered observation count of mapped unique peptides and those of unmapped ones was examined. The filtered observation count of the unmapped peptides was significantly lower (up to ˜37 counts) than that of the mapped ones (up to ˜63,000 counts), suggesting that these are most likely measurement errors (i.e., false positives from mass spectrometry analysis). This analysis yielded 3,247 preliminary pORFs. However, it was often observed that multiple pORFs from different translational frames that were largely overlapped. As such, the peptides mapped onto the overlapped pORFs were compared, suggesting that the bona fide pORFs contain multiple peptides with high frequency of peptide detection. As another criterion, mRNA transcript profiles were used to infer the translation directionality (i.e., translated strand) of the overlapped pORFs. This stringent analysis removed a total of 790 unique peptides. A total of 921 peptides (131 peptides from mORF mapping+790 peptides from the above stringent test) were considered as the false positives, suggesting that the false positive discovery rate (FDR) was <2%. This analysis yielded 2,542 pORFs (FDR<2%). To determine pORFs in the same TU, each pORF was mapped to RNAP-guided transcript segment using their genomic positions.

Determination of transcription units—To determine the transcription units (TUs), the modular units were first assembled based on the break point results obtained from the change point detection algorithm. A total of 61 modular units (<2%) obtained from the current annotation lacked any experimentally determined organizational components. These modular units indicate that specific growth conditions are required to determine their organizational components. For example, one modular unit contains the rha operon that encodes metabolic enzymes related with rhamnose metabolism requiring rhamnose as an environmental cue.

### EXAMPLE 2

### Metastructure Determination if E. Coli K-12 MG1655

This example demonstrates data integration and analysis to determine the metastructure of the E. coli K-12 MG1655 genome.

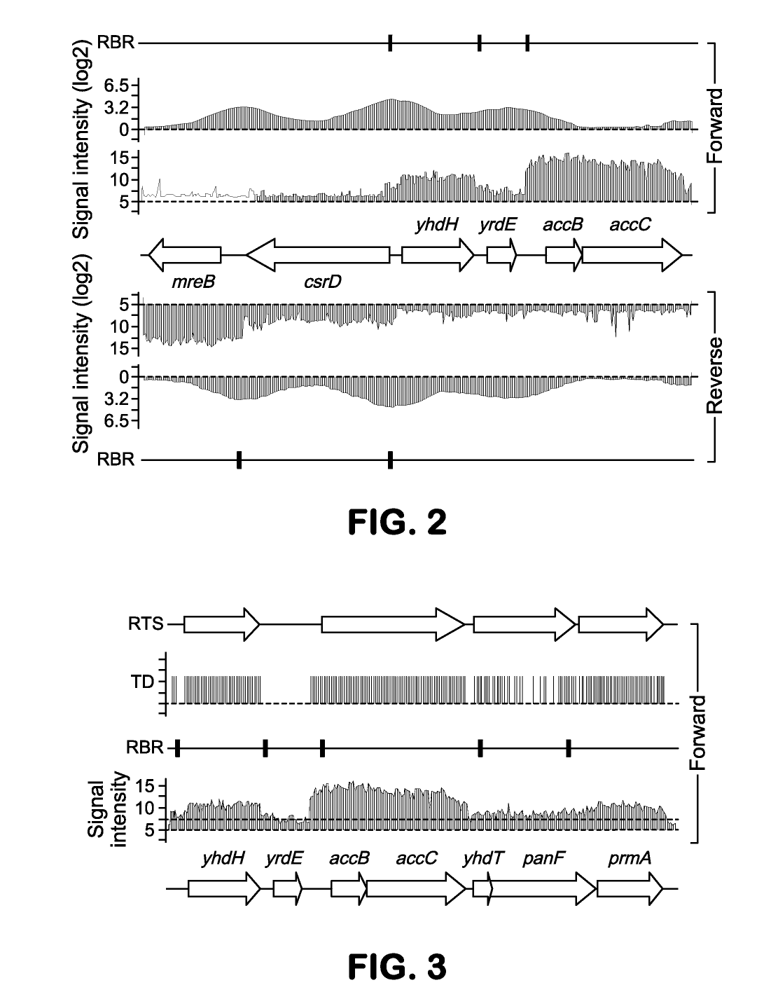

Determination of RNA polymerase binding regions at a genome-scale—The first step is to establish a description of the flow of genetic information is its transfer into messenger RNA (mRNA) by the transcription process. Although this process is extensively regulated in response to external signals, mRNA is basically synthesized by RNA polymerase (RNAP) that initially binds to the promoter region. Therefore, RNAP-binding regions and mRNA transcript abundance were integrated to determine segments of contiguous transcription originating from promoter regions. To identify RNAP-binding regions at a genome scale, a ChIP-chip method was employed to E. coli K-12 MG1655 grown in the presence or absence of rifampicin under multiple growth conditions. Using an antibody specific to the RNAP β subunit, RNAP-associated DNA fragments were obtained that were then fluorescently labelled and hybridized to a high-density oligonucleotide tiling microarray representing the entire E. coli genome. Rifampicin treatment generated a genome-wide static map of RNAP-binding regions compared to a dynamic map of RNAP-binding regions without rifampicin treatment. From this static map, a total of 1,511 and 1,444 RNAP-binding regions were identified on the forward and reverse strand, respectively (FIG. 2, see, e.g., Table 1 on the world wide web at systemsbiology.ucsd.edu/tables, current as of Oct. 29, 2010, herein incorporated by reference in its entirety), essentially representing the promoter regions at a genome-scale. Table 1 provides data from the genome-scale determination of RNA polymerase binding regions (RBRs). “Static” and “Dynamic” indicate RNA polymerase ChIP-chip experiments with rifampicin treatment and without treatment, respectively. Each value in columns 3-7 indicates binding levels (log 2 ratio) of RNA polymerase under log phase (log), heat-shocked (heat), stationary phase (stat), and glutamine (gln) growth conditions. Interestingly, the locations of RNAP-binding regions obtained from rifampicin-treated cells are nearly independent of the experimental conditions used. This observation could be due to the stochastic interaction between repressors and regulatory regions known to cause random bursts in transcription in vivo. The dynamic maps in contrast indicate differential RNAP binding across the entire genome, representing the genome-wide rearrangement of RNAP in response to environmental conditions. Considering the current E. coli genome annotation (4,505 genes in total), an average of one RNAP-binding region per every 1.5 genes was determined.

Integration of the RNAP-binding regions and transcriptomic data—In the second step, comprehensive information was obtained about the expression level of mRNA transcripts across the entire E. coli genome using tiling microarrays to profile transcriptomes under multiple growth conditions. These growth conditions included log-phase, heat-shocked, stationary phase, and a different nitrogen source. Negative control probes that represent non-specific background hybridization were randomly selected based on the median signal intensity (depicted as a dotted line in FIG. 3). The microarray signals were subsequently transformed to binary signals, representing presence (probes expressed above background) and absence probes (background). Transcription data obtained from multiple growth conditions were added cumulatively in a step-by-step approach. These rounds of iteration resulted in coverage of 73.0%, 80.2%, 86.8%, and 87.4% of the currently annotated genome, respectively (see, e.g., Table 2 on the world wide web at systemsbiology.ucsd.edu/tables, current as of Oct. 29, 2010, herein incorporated by reference in its entirety). Table 2 provides iterative analysis data of expression profiles. “Total probes” indicates total number of probes within ORF region. “Expressed probes” was determined by transcriptiondetector algorithm. “Probe density (%)” shows the ratio between the expressed probe and total probes within ORF region. Abbreviations: R1, log phase; R2, log phase+heat-shocked condition; R3, log phase+heat-shocked condition+stationary phase; R4, log phase+heat-shocked condition+stationary phase+glutamine growth condition; P, presence; A, absence; U, uncharacterized gene.

The last iteration result (i.e., cumulative integration of microarray results from four growth conditions) represents 118,767 probes detected above background level (false discovery rate (FDR) threshold=0.05) (see, e.g., Table 1 on the world wide web at systemsbiology.ucsd.edu/tables, current as of Oct. 29, 2010, herein incorporated by reference in its entirety). A total of 567 genes (12.6%) fell below FDR threshold consisting of 409 uncharacterized and 158 currently known genes. Within the known genes, several, such as rhaBADM, tynA, and speF, are only functional under specific growth conditions and are therefore unlikely to be detected under the conditions used (see, e.g., Table 2 on the world wide web at systemsbiology.ucsd.edu/tables, current as of Oct. 29, 2010, herein incorporated by reference in its entirety). In addition, transcription of a total of ˜140 kb was detected, which had not been annotated as ORFs previously.

The RNAP-binding regions and transcriptomic data were integrated to obtain a map of contiguous transcript segments (i.e., RNAP-guided transcript segments), which is independent of the current genome annotation. The binary signals (i.e., presence (1) or absence (0) calls) were then partitioned into segments of constant signals separated by RNAP-binding regions determined above (FIG. 3). Compared to a change point detection algorithm and a running-window approach, the RNAP-guided transcript segmentation method, i.e., integrating the binary transcript signals with the RNAP-binding information, circumvents the assembly of unrelated transcripts and greatly benefits further TU determination.

A total of 1,364 and 1,321 segments with average length of 1.3 kb was determined from the cumulative iterations on the forward and reverse strand, respectively (see, e.g., Table 3 on the world wide web at systemsbiology.ucsd.edu/tables, current as of Oct. 29, 2010, herein incorporated by reference in its entirety). Table 3 provides iterative determination data of RNAP-guided transcript segments (RTSs). Abbreviations: R1, log phase; R2, log phase+heat_shocked condition; R3, log phase+heat_shocked condition+stationary phase; R4, log phase+heat_shocked condition+stationary phase+glutamine growth condition; Len, Length (bp); Den, Density (%). Among those, a total of 98 segments were determined without RNAP-binding. The genomic coverage of the segments was ˜81% with an average probe density of ˜83% per segment. With each iteration, boundary accuracy and probe density of the segments increased (see, e.g., Table 3 on the world wide web at systemsbiology.ucsd.edu/tables, current as of Oct. 29, 2010, herein incorporated by reference in its entirety). A total of 253 segments were determined in regions of the genome lacking prior ORF annotation, including 82 segments in intergenic regions, 147 segments on opposite annotated strand, and 24 segments in intragenic regions.

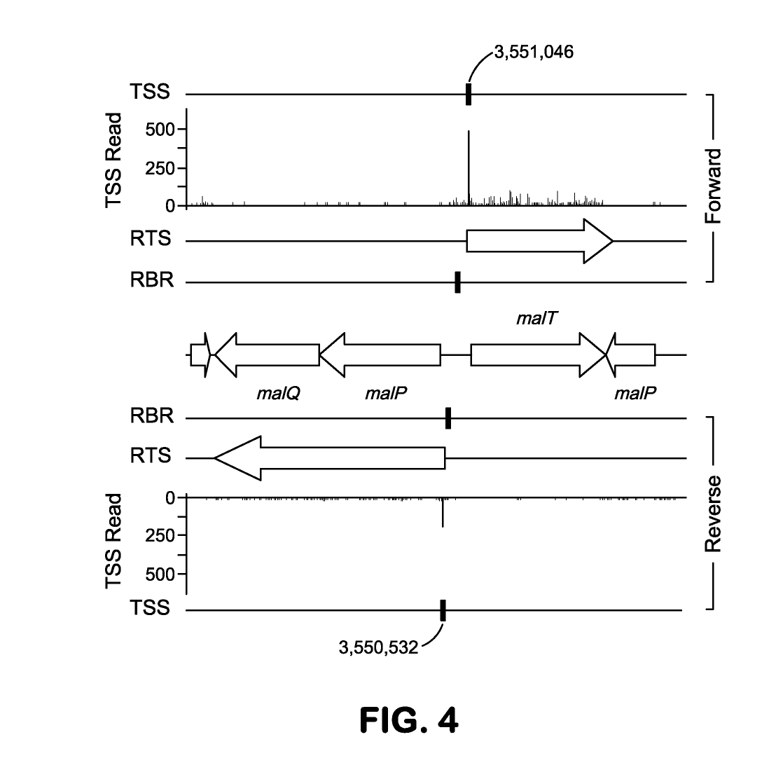

Determination of transcription start sites—In the third step, the RNAP-guided transcript segments were integrated with genome-wide TSSs data (FIG. 4). TSSs were determined by a newly developed, modified 5′-RACE method using a unique RNA adapter and massive-scale sequencing. Three cumulative iterations yielded>4.4 million sequence reads of an average length of 30 bp corresponding to ˜30× genome lengths (˜133 Mb raw sequence data). Sequence reads were mapped back onto the reference E. coli genome (NC_{—}000913) to determine the numbers of reads matching each genomic position. Approximately 64% of the sequence reads uniquely mapped to one genomic region, whereas the remaining reads either mapped to repeated sequences or were of poor quality. Mapping the reads to the genome allowed the determination of 3,969 TSSs from the first iteration, and 4,062 and 4,133 TSSs from consecutively cumulative iterations (see, e.g., Table 4 on the world wide web at systemsbiology.ucsd.edu/tables, current as of Oct. 29, 2010, herein incorporated by reference in its entirety). Table 4 provides data from the genome-scale determination of transcription start sites (TSSs), mapping onto RTSs. Each promoter region (2,955 in total) averages 1.6 TSSs. For confirmation, the data was compared to currently validated TSSs and found that 87% (1,089 out of 1,252) of the validated TSSs agreed to TSSs obtained from this study (see, e.g., Table 5 on the world wide web at systemsbiology.ucsd.edu/tables, current as of Oct. 29, 2010, herein incorporated by reference in its entirety). Table 5 provides comparison data of previously known TSSs to TSSs obtained from this study.

The 13% of the validated TSS (corresponding to 146 TUs) not detected in this study could be due to low mRNA expression levels as well as condition specific use of TSSs. For example, the validated TSSs for narK, a gene encoding a nitrate/nitrite antiporter expressed under anaerobic growth condition, were not detected in this study. This could be explained by nearly background mRNA levels for this gene under the applied conditions. Another example is the ilvIH operon, encoding acetolactate synthase involved in the amino acid biosynthesis. The ilvIH operon has four experimentally verified TSSs. Among those, only one TSS, which is highly regulated by the transcription factor Lrp under the herein described growth conditions was detected. On the other hand, it was found that ˜2% of TSSs (97 out of 4,133) were from weakly transcribed genes and that ˜5% of RNAP-guided transcript segments (145 out of 2,685) lacked TSSs. Consequently, integration of the TSSs with the RNAP-guided transcript segments allowed us to determine a total of 4,036 TSS-associated transcriptional segments.

Identification of potential protein-coding ORFs—In the fourth step, the number of potential protein-coding ORFs (pORFs) that are within each RNAP-guided transcript segment was addressed by using a high-throughput proteomics approach for identifying peptides at a genome-scale. This approach was based on liquid chromatography coupled to Fourier transform ion cyclotron resonance mass spectrometry (LC-FTICR-MS) and accurate mass and time tag (AMT tag). The proteomics analysis yielded a total of 54,549 peptides based on a stop-to-stop database of the E. coli genome (see, e.g., Table 6 on the world wide web at systemsbiology.ucsd.edu/tables, current as of Oct. 29, 2010, herein incorporated by reference in its entirety). Table 6 provides genome-scale proteomic data obtained from log phase, heat-shocked stationary phase growth conditions (this study), and from publicly available sources.

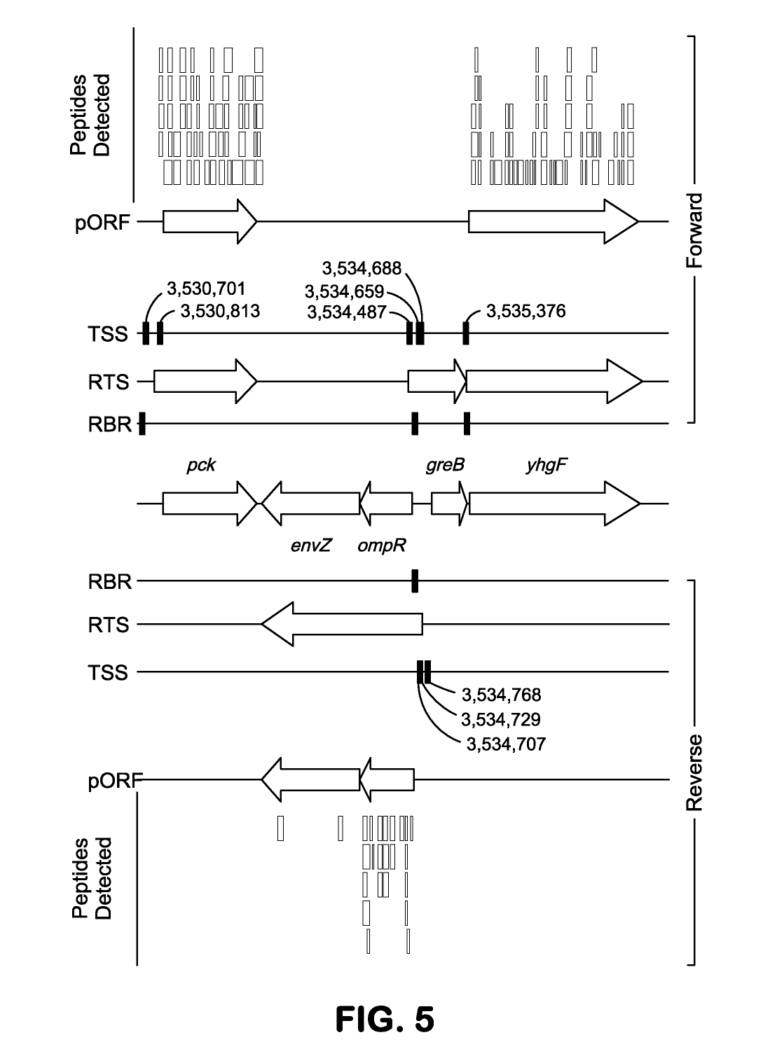

To predict pORFs from proteomics data without relying on current annotation, the genomic locations of peptides were mapped onto a maximally extendable ORF scaffold (i.e., stop codon to most distant start codon) built from all six possible translational frames (see, e.g., Table 7 on the world wide web at systemsbiology.ucsd.edu/tables, current as of Oct. 29, 2010, herein incorporated by reference in its entirety). Thus, Table 7 provides maximally extendable ORFs predicted from all six possible translational frames. This analysis yielded 2,542 pORFs (FDR<2%) (FIG. 5, see, e.g., Table 8 on the world wide web at systemsbiology.ucsd.edu/tables, current as of Oct. 29, 2010, herein incorporated by reference in its entirety). Table 8 provides genome-wide determination data of potential ORF from maximally extendable ORGs and proteomics data sets. Among those, 2,525 pORFs (˜99%) were mapped to currently annotated ORFs (˜59% coverage) (see, e.g., Table 8 on the world wide web at systemsbiology.ucsd.edu/tables, current as of Oct. 29, 2010, herein incorporated by reference in its entirety). Interestingly, >99% of translation stop positions were exactly matched to currently annotated ORFs, however, only 64% of translation start positions were matched.

To examine the accuracy of translation start and stop positions, pORFs were compared with a total of 888 ORFs whose translational boundaries have been validated. Out of 2,525 pORFs, 803 pORFs were mapped to validated ORFs. All the translation stop position of these 803 pORFs matched the validated ones exactly. However, only 499 pORFs (accuracy=˜62%) showed identical translation start positions (see, e.g., Table 9 on the world wide web at systemsbiology.ucsd.edu/tables, current as of Oct. 29, 2010, herein incorporated by reference in its entirety). Table 9 provides boundary accuracy data of pORFs. To examine boundary accuracy, pORFs were compared with ORFs whose translational boundaries have been validated by their N-termini sequences (from EcoGene). 803 pORFs were identified and mapped to the validated ORFs (˜89%), of which 499 pORFs represent the identical 5′ and 3′ boundaries (accuracy=˜62%). When we considered the translation start codon selected from the nearest peptide(s) found (npORF), 507 pORFs (accuracy=˜63%) were matched with the validated ORFs. By considering translation start codons that were closest to the observed peptide(s) within pORFs, increase of accuracy that matched validated ORFs was negligible (507 pORFs). pORFs with non-matching translation start positions (296 pORFs) exhibited poor peptide coverage. Overall, the proteogenomic mapping approach allows for the genome-scale determination of ORFs, however, due to limitation in peptide coverage, additional methods, e.g. proteomics with N-terminal modification, have to be applied to obtain a more comprehensive and accurate ORF map.

A total of 2,385 pORFs showed direct evidence of transcription after mapping them to the RNAP-guided transcript segments identified above (see, e.g., Table 10 on the world wide web at systemsbiology.ucsd.edu/tables, current as of Oct. 29, 2010, herein incorporated by reference in its entirety). Moreover, 17 pORFs in genomic regions lacking prior annotation were identified. Among those, mRNA transcripts of 12 pORFs were confirmed by transcriptomic analysis, suggesting additional ORFs compared to the current genome annotation (see, e.g., Table 10 on the world wide web at systemsbiology.ucsd.edu/tables, current as of Oct. 29, 2010, herein incorporated by reference in its entirety). Table 10 provides mapping data of pORFs to RTSs. The current genome annotation still contains 2,087 gene loci that are listed as “predicted”, i.e., without any experimental verification. Over 42% (878) of these predicted gene loci were mapped onto pORFs, suggesting they were translated into proteins under growth conditions applied (see, e.g., Table 9 on the world wide web at systemsbiology.ucsd.edu/tables, current as of Oct. 29, 2010, herein incorporated by reference in its entirety).

Analysis of characteristics of the metastructure: Determination of transcription unit architecture—By using the organizational components, 3,138 modular units of the E. coli genome representing potential transcription units were defined. Each modular unit contains information on (i) promoter region, (ii) transcription start sites (TSSs), (iii) transcribed regions, and (iv) ORFs, consisting of pORFs and currently annotated ORFs (see, e.g., Table 11 on the world wide web at systemsbiology.ucsd.edu/tables, current as of Oct. 29, 2010, herein incorporated by reference in its entirety). Table 11 provides genome-scale determination of modular units (MUs) representing potential transcript unit (MU). The modular unit defined based on this data is different from the classic definition of an operon, since operons do not allow for nested TUs. It was consequently determined that the transcription unit (TU) architecture of the E. coli genome that result from condition-dependent combination of the modular units. In general, a TU in a bacterial genome is defined as having multiple ORFs that are transcribed from one promoter to synthesize a single mRNA transcript. Conceptually, expression levels of multiple modular units within a single TU remain constant without an expression gap between them, assuming absence of differential mRNA degradation.

These criteria allowed assembling modular units to determine TU architecture at a genome-scale using the change point detection algorithm. One TU can be identified from a series of contiguous modular units based upon their transcription termination position. On the other hand, multiple TUs can be obtained from a single modular unit, if it contains multiple TSSs (FIG. 7). In total, 4,661 TUs were determined, of which 3,946 (˜86%) were fully supported by all organizational components (see, e.g., Table 12 on the world wide web at systemsbiology.ucsd.edu/tables, current as of Oct. 29, 2010, herein incorporated by reference in its entirety). Table 12 provides data from the determination of transcription units architecture and calculation of 5′UTR length. This represents an increase of >530% compared to the experimentally validated 875 TUs (see, e.g., Table 13 on the world wide web at systemsbiology.ucsd.edu/tables, current as of Oct. 29, 2010, herein incorporated by reference in its entirety). Table 13 provides comparison data of TUs to the previously experimentally determined TUs. While 72 TUs (˜8%) were not determined in this analysis due to lacks of identified TSSs, a total of 1,786 TUs (˜72%) were consistent with computationally predicted TUs (see, e.g., Table 14 on the world wide web at systemsbiology.ucsd.edu/tables, current as of Oct. 29, 2010, herein incorporated by reference in its entirety). Each of the 4,661 TUs is comprised of an average of 1.1 modular units with the largest TU (TU-0061) containing nine modular units equivalent to 16 ORFs (see, e.g., Table 12 on the world wide web at systemsbiology.ucsd.edu/tables, current as of Oct. 29, 2010, herein incorporated by reference in its entirety). A total of 3,010 TUs (˜65%) are monocistronic, while 1,652 TUs contain more than one ORF (polycistronic). 398 TUs (˜9%) were comprised of multiple modular units that are nested within each other, defining a convoluted genome structure (FIG. 7). These nested TU architecture might therefore increase the flexibility of expression states of bacterial genomes without increasing genome size.

Taken together, the extensive experimental results presented demonstrate how the organizational components of the bacterial genome can be experimentally obtained. The determination of the components requires multiple genome-scale measurements and their iterative and systematic integration (FIG. 1). The determination of organizational components for the E. coli K-12 MG1655 genome notably improves the knowledge and understanding of this widely studied genome. The process developed and implemented here can be applied to other prokaryotic organisms. The result is an experimental annotation of a genome and it provides the scaffold on which the transcriptional and translational regulatory network will be built.

Although the invention has been described with reference to the above example, it will be understood that modifications and variations are encompassed within the spirit and scope of the invention. Accordingly, the invention is limited only by the following claims.

1. A method of building a metastructure for a target organism comprising:
(a) obtaining the full genome sequence a target organism;
(b) obtaining the genome-wide binding of RNA polymerase from the organism;
(c) obtaining the transcription of RNA from the organism;
(d) obtaining the 5′ end sequence of the RNA molecules from the organism;
(e) obtaining proteomic data from the total protein isolated from the organism;
(f) obtaining the data described in (b) through (e) under a series of culture conditions for the organism; and
(g) iteratively mapping the data sets described in (f) onto the DNA sequence in (a) to build the metastructure for the target organism.

2. The method of claim 1, wherein the target organism is a bacterial organism.

3. The method of claim 1, wherein the target organism is an archeal organism.

4. The method of claim 1, wherein the genome-wide binding of RNA polymerase is obtained by chromatin immunoprecipitation coupled with a microarray.

5. The method of claim 1, wherein the genome-wide binding of RNA polymerase is obtained by deep sequencing of immunoprecipitated DNA.

6. The method of claim 1, wherein the transcription of RNA is obtained using tiled expression arrays.

7. The method of claim 1, wherein the transcription of RNA is obtained using deep sequencing of the isolated RNA.

8. The method of claim 1, wherein the 5′ end sequence of the RNA molecules is obtained by deep sequencing of RNA.

9. The method of claim 1, wherein the proteomic data from the total protein is obtained by mass spectrometry.

10. The method of claim 1, wherein a list of open reading frames is obtained from said proteomic data.

11. The method of claim 1, wherein the culture conditions are selected from the group consisting of oxygen levels, nutrient levels, temperature, pressure, light, metal, other chemicals, and other environmental stimuli.

12. The method of claim 1, further comprising:
(a) obtaining transcription boundaries from the genome-wide binding of RNA polymerase and transcription of RNA;
(b) assigning the 5′ end sequence of the RNA molecules to each transcription boundary; and
(c) assigning the open reading frames to each transcription boundary, thereby identifying modular units on a genome-scale for said target organism.

13. The method of claim 11, further comprising:
(a) determining a change point in the DNA genomic sequence of RNA expression levels;
(b) combining the modular units based on the change points into transcription units;
(c) determining a start of the transcription unit using the TSS data for the lead modular unit in the said combination of modular units; and
(d) using (a)-(c) to define the start and end of the transcription unit under said culture condition,
thereby determining transcription units on a genome-scale for said target organism under a culture condition.

14. A method for designing tunable promoters that function in the context of the entire organism to produce a protein in a culture condition specific manner comprising:
(a) identifying a plurality of transcription units that contain the same genes but different starting sites;
(b) selecting one of said transcription units based on start site properties that are used in a culture condition specific manner;
(c) choosing said start site properties based on the start site itself and the UTR sequence and its associated regulatory function,
thereby expressing the target gene to produce the specified protein under the chosen culture condition.

15. The method of claim 14, wherein the protein is a heterologous protein introduced into the modular unit(s) of the transcription unit desired to be produced under the chosen cell culture condition.

16. The method of claim 14, wherein the UTR of specified properties is introduced upstream from the gene in a modular unit of interest such that the encoded protein is produced under the chosen cell culture condition.

17. A library of reporter vectors to specify the expression level of a protein in a transcription unit comprising of a plurality of different plasmids defined by:
(a) a TSS and 5′UTR derived from the metastructure of said target organism; and
(b) a reporter gene that produces a detectable protein product.

18. The library of claim 17, wherein a selectable marker gene is introduced to enable the isolating and cloning of a strain that harbors a particular plasmid in the library.

19. The library of claim 17, wherein there are different reporter genes in each selected transcription unit represented on a plasmid.

20. A method of identifying the expression level of RNA in a transcription unit in the library of claim 17.

21. The library of claim 17 where the reporter gene is GFP or YFP.

22. A strain library of reporter vectors, wherein the strain is E. coli MG1655.


SEQUENCE LISTING (4 sequences)

SEQ ID NO: 1 - RNA, 28 nt, Artificial Sequence
  Synthetic construct
guucagagaguucuacaguccgacgauc

SEQ ID NO: 2 - DNA, 30 bp, Artificial Sequence
  Synthetic construct
caagcagaagacggcatacgannnnnnnnn

SEQ ID NO: 3 - DNA, 21 bp, Artificial Sequence
  Primer
caagcagaagacggcatacga

SEQ ID NO: 4 - DNA, 44 bp, Artificial Sequence
  Primer
aatgatacggcgaccaccgacaggttcagagttctacagtccga